(19) United States
(12) Patent Application Publication
(10) Pub. No.: US 2025/0034721 A1
(43) Pub. Date: Jan. 30, 2025

(54) SYSTEMS AND METHODS FOR SEPARATION OF CARBON DIOXIDE

(71) Applicant: Massachusetts Institute of Technology, Cambridge, MA (US)

(72) Inventors: Betar Gallant, Cambridge, MA (US); Fang-Yu Kuo, Cambridge, MA (US)

(73) Assignee: Massachusetts Institute of Technology, Cambridge, MA (US)

(21) Appl. No.: 18/359,672

(22) Filed: Jul. 26, 2023

(51) Int. Cl. C25B 1/00; C25B 3/09; C25B 9/17; C25B 11/047; C25B 15/08

(52) U.S. Cl. CPC C25B 1/00; C25B 3/09; C25B 9/17; C25B 11/047; C25B 15/083

(57) ABSTRACT

Systems and methods related to the separation of carbon dioxide (CO₂) from a fluid source are generally described.

### TECHNICAL FIELD

Systems and methods related to the separation of carbon dioxide (CO₂) from a fluid source are generally described.

### BACKGROUND

Conventional industrial amine scrubbing processes for post-combustion CO₂ capture require up to 30% of a power plant's capacity since a high-temperature regeneration step is employed after capturing the CO₂ to break the bond between amine and CO₂ and release CO₂ for storage. Furthermore, the high temperature environment causes severe amine degradation, which leads to performance decay, extra capital costs, and environmental issues. Electrochemical approaches for amine regeneration are promising alternatives to address the above issues as they offer several benefits over thermal-based ones, including direct integration with renewable energy and ambient operating conditions, which could support a more sustainable CO₂ separation process.

### SUMMARY

The present disclosure is related to systems and methods for the separation of CO₂, for example, from a fluid source. The subject matter of the present invention involves, in some cases, interrelated products, alternative solutions to a particular problem, and/or a plurality of different uses of one or more systems and/or articles.

According to certain embodiments, an electrochemical system is described. In some embodiments, the electrochemical system comprises a salt comprising a first Lewis acid cation, a carbamic acid compound, and an electrochemical cell comprising an electrode. In certain embodiments, upon discharge or charge of the electrochemical cell, the electrode is configured to produce a second Lewis acid cation that interacts with the carbamic acid compound to release CO₂ from the carbamic acid compound. In some embodiments, the second Lewis acid cation is a stronger Lewis acid than the first Lewis acid cation.

According to some embodiments, an electrochemical system comprises a fluid source comprising: an electrolyte salt comprising a first Lewis acid cation; and a carbamic acid compound. In certain embodiments, the electrochemical system comprises an electrochemical cell comprising a positive electrode and a negative electrode. In some embodiments, upon discharge of the electrochemical cell, the negative electrode is configured to produce a second Lewis acid cation that interacts with the carbamic acid compound to release CO₂ from the carbamic acid compound, thereby separating CO₂ from the fluid source. In certain embodiments, the second Lewis acid cation is a stronger Lewis acid that the first Lewis acid cation.

According to certain embodiments, an electrochemical system comprises a fluid source comprising: an electrolyte salt comprising a first Lewis acid cation; and a carbamic acid compound. In some embodiments, the electrochemical system comprises an electrochemical cell comprising a positive electrode and a negative electrode. In certain embodiments, upon charge of the electrochemical cell, the positive electrode is configured to produce a second Lewis acid cation that interacts with the carbamic acid compound to release CO₂ from the carbamic acid compound, thereby separating CO₂ from the fluid source. In some embodiments, the second Lewis acid cation is a stronger Lewis acid than the first Lewis acid cation.

According to some embodiments, a method of releasing CO₂ is described. In certain embodiments, the method comprises discharging or charging an electrochemical cell in the presence of a first Lewis acid cation, thereby producing a second Lewis acid cation from an electrode of the electrochemical cell, wherein the second Lewis acid cation interacts with a carbamic acid compound and releases CO₂ from the carbamic acid compound, and wherein the second Lewis acid cation is a stronger Lewis acid than the first Lewis acid cation.

According to certain embodiments, a method of separating CO₂ from a fluid source is described. In some embodiments, the method comprises: providing an electrochemical cell in the fluid source, wherein the electrochemical cell comprises a positive electrode and a negative electrode, and the fluid source comprises an electrolyte salt and a carbamic acid compound, and wherein the electrolyte salt comprises a first Lewis acid cation; discharging the electrochemical cell, wherein the discharging comprises producing a second Lewis acid cation from the negative electrode such that the second Lewis acid cation interacts with the carbamic acid compound and releases CO₂ from the carbamic acid compound, wherein the second Lewis acid cation is a stronger Lewis acid than the first Lewis acid cation; and separating CO₂ from the fluid source.

According to some embodiments, a method of separating CO₂ from a fluid source comprises: providing an electrochemical cell in the fluid source, wherein the electrochemical cell comprises a positive electrode and a negative electrode, and the fluid source comprises an electrolyte salt and a carbamic acid compound, and wherein the electrolyte salt comprises a first Lewis acid cation; charging the electrochemical cell, wherein the charging comprises producing a second Lewis acid cation from the positive electrode such that the second Lewis acid cation interacts with the carbamic acid compound and releases CO₂ from the carbamic acid compound, wherein the second Lewis acid cation is a stronger Lewis acid than the first Lewis acid cation; and separating CO₂ from the fluid source.

According to some embodiments, a method of separating CO₂ from a fluid source comprises: providing an electrochemical cell in the fluid source, wherein the electrochemical cell comprises a positive electrode and a negative electrode, and the fluid source comprises an electrolyte salt and a carbamic acid compound, and wherein the electrolyte salt comprises a first Lewis acid cation; discharging the electrochemical cell, wherein the discharging comprises producing a second Lewis acid cation from the negative electrode such that the second Lewis acid cation interacts with the carbamic acid compound and releases CO₂ from the carbamic acid compound, and wherein the discharging comprises intercalating the first Lewis acid cation into the positive electrode; separating CO₂ from the fluid source; and charging the electrochemical cell, wherein the charging comprises plating the second Lewis acid cation onto the negative electrode, and wherein the charging comprises de-intercalating the first Lewis acid cation from the positive electrode.

According to certain embodiments, a method of separating CO₂ from a fluid source comprises: providing an electrochemical cell in the fluid source, wherein the electrochemical cell comprises a positive electrode and a negative electrode, and the fluid source comprises an electrolyte salt and a carbamic acid compound, and wherein the electrolyte salt comprises a first Lewis acid cation; charging the electrochemical cell, wherein the charging comprises producing a second Lewis acid cation from the positive electrode such that the second Lewis acid cation interacts with the carbamic acid compound and releases CO₂ from the carbamic acid compound, and wherein the charging comprises plating the first Lewis acid cation onto the negative electrode or intercalating the first Lewis acid cation into the negative electrode; separating CO₂ from the fluid source; and discharging the electrochemical cell, wherein the discharging comprises intercalating the second Lewis acid cation into the positive electrode, and wherein the discharging comprises producing the first Lewis acid cation from the negative electrode or de-intercalating the first Lewis acid cation from the negative electrode.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1A shows, according to certain embodiments, a schematic diagram of an electrochemical system.

FIG. 1B shows, according to certain embodiments, a schematic diagram of the electrochemical system of FIG. 1A during discharge.

FIG. 1C shows, according to certain embodiments, a schematic diagram of the electrochemical system of FIG. 1A during discharge, wherein a second Lewis acid cation has interacted with a carbamic acid compound.

FIG. 1D shows, according to certain embodiments, a schematic diagram of the electrochemical system of FIG. 1A after discharge.

FIG. 1E shows, according to certain embodiments, a schematic diagram of the electrochemical system of FIG. 1A during charge.

FIG. 1F shows, according to certain embodiments, a schematic diagram of the electrochemical system of FIG. 1A during charge, wherein a second Lewis cation has de-interacted from a carbamate compound-second Lewis acid cation adduct.

FIG. 1G shows, according to certain embodiments, a schematic diagram of the electrochemical system of FIG. 1A after charge.

FIG. 1H shows, according to certain embodiments, a schematic diagram of the electrochemical system of FIG. 1A after charge, wherein the fluid source has been purged with CO₂.

FIG. 2A shows, according to certain embodiments, a schematic diagram of an electrochemical system comprising one or more fluidic connections for removing CO₂ from the electrochemical system.

FIG. 2B shows, according to certain embodiments, a schematic diagram of an electrochemical system comprising one or more fluidic connections for introducing CO₂ into the electrochemical system.

FIG. 3A shows, according to certain embodiments, an electrochemical system comprising a first electrode configured to de-intercalate a second Lewis acid cation and a second electrode configured to plate a first Lewis acid cation upon charge.

FIG. 3B shows, according to certain embodiments, of the electrochemical system of FIG. 3A comprising a first electrode configured to intercalate a second Lewis acid cation and a second electrode configured to produce a first Lewis acid cation upon discharge.

FIG. 4 shows, according to certain embodiments, a schematic diagram of an electrochemical system configured as a flow cell.

FIG. 5A shows, according to certain embodiments, a schematic diagram of a dual-ion cell during discharge and charge.

FIG. 5B shows, according to certain embodiments, the standard reduction potentials of Prussian blue and various metal cations.

FIG. 6A shows, according to certain embodiments, proton nuclear magnetic resonance (¹H NMR) spectra of dimethyl sulfoxide (DMSO)-d₆ containing 2-ethoxyethylamine (EEA)-CO₂ without salt and with various metal salts (left) and a reaction scheme of the formation of ammonium and carbamate (right).

FIG. 6B shows, according to certain embodiments, percent carbamate conversion determined as a function of time after salt addition.

FIG. 6C shows, according to certain embodiments, CO₂ loading of 0.1 M and 0.5 M EEA-CO₂ in DMSO in the presence of different concentrations of cations.

FIG. 6D shows, according to certain embodiments, percent cation efficiency of converting carbamic acid to ammonium carbamate based on 0.15 M cation charge.

FIG. 7A shows, according to certain embodiments, a schematic diagram of the experimental setup used to chemically validate cation-induced CO₂ release upon introducing zinc cation (Zn²⁺)/amine to potassium cation (K⁺)/amine solutions.

FIG. 7B shows, according to certain embodiments, CO₂ concentration after baseline subtraction measured as a function of time by a CO₂ sensor after injecting a Zn²⁺-containing salt electrolyte of various concentrations.

FIG. 7C shows, according to certain embodiments, the integrated amount of CO₂ release at various Zn²⁺ concentrations, compared to the expected amount from NMR measurements.

FIG. 8A shows, according to certain embodiments, reaction schemes for carbamic acid (ΔH_{0%}) or carbamate/ammonia (ΔH_{50%}) formation from lean amine and CO₂(g), and their interconversion (ΔH_{conversion}).

FIG. 8B shows, according to certain embodiments, reaction enthalpies after purging CO₂ into solution vials containing 0.1 M EEA/DMSO and different concentrations of various cations.

FIG. 8C shows, according to certain embodiments, a comparison of ΔH_{0%}, ΔH_{50%}, and ΔH_{conversion} in electrolytes with various cations.

FIG. 8D shows, according to certain embodiments, Fourier transform infrared (FTIR) spectra of DMSO-d₆ electrolyte containing various metal salts.

FIG. 8E shows, according to certain embodiments, a schematic diagram of proposed molecular interactions in a Zn²⁺-containing electrolyte.

FIG. 8F shows, according to certain embodiments, the energy landscape of carbamic acid and ammonium carbamate in the Zn²⁺-containing electrolytes versus other cations.

FIG. 9A shows, according to certain embodiments, charge/discharge curves of a Prussian white (PW)/zinc (Zn) full cell at 30 mA g⁻¹.

FIG. 9B shows, according to certain embodiments, changes of Zn²⁺ concentration and CO₂ loading on amines at each cell cycling step.

FIG. 9C shows, according to certain embodiments, two-electrode charge and discharge curves for a PW/Zn full cell with amine at 30 mA g⁻¹ for 30 cycles.

FIG. 9D shows, according to certain embodiments, long-term cycling performances of a PW/Zn full cell at 30 mA g⁻¹ for 30 cycles.

FIG. 10 shows, according to certain embodiments, ¹H NMR spectra of 0.1 M EEA-CO₂ with no salt in DMSO.

FIG. 11 shows, according to certain embodiments, carbamate conversion measured by ¹H NMR with different CO₂ or argon (Ar) gas purge times.

FIG. 12 shows, according to certain embodiments, lithium nuclear magnetic resonance (⁷Li NMR) of a precipitate from 0.5 M EEA/0.50 M lithium bis(trifluoromethanesulfonyl)imide (LiTFSI) in DMSO.

FIG. 13A shows, according to certain embodiments, raw data of CO₂ concentration after 0.025 M zinc bis(trifluoromethanesulfonyl)imide (Zn(TFSI)₂) injection.

FIG. 13B shows, according to certain embodiments, raw data of CO₂ concentration after 0.050 M Zn(TFSI)₂ injection.

FIG. 13C shows, according to certain embodiments, raw data of CO₂ concentration after 0.075 M Zn(TFSI)₂ injection.

FIG. 13D shows, according to certain embodiments, raw data of CO₂ concentration after 0.100 M Zn(TFSI)₂ injection.

FIG. 13E shows, according to certain embodiments, raw data of CO₂ concentration after 0.150 M Zn(TFSI)₂ injection.

FIG. 13F shows, according to certain embodiments, raw data of CO₂ concentration after 0.200 M Zn(TFSI)₂ injection.

FIG. 14A shows, according to certain embodiments, a X-ray diffraction (XRD) pattern of synthesized PW.

FIG. 14B shows, according to certain embodiments, a SEM image of PW particles with a particle size of 30 to 50 nm.

FIG. 15 shows, according to certain embodiments, a schematic diagram of a custom two-electrode electrochemical cell outfitted with valves for headspace purging or sampling.

FIG. 16 shows, according to certain embodiments, a calibration curve of the Zn²⁺ signal using a commercial Zn standard.

FIG. 17 shows, according to certain embodiments, calibration of the CO₂ signal using sodium bicarbonate (NaHCO₃) standards.

FIG. 18A shows, according to certain embodiments, two-electrode charge and discharge curves for a PW/Zn full cell without amine at 30 mA g⁻¹ for 30 cycles.

FIG. 18B shows, according to certain embodiments, a summary of capacity and Coulombic efficiency of a PW/Zn full cell without amine for 30 cycles.

FIG. 19A shows, according to certain embodiments, charge and discharge curves for a PW three-electrode cell without EEA-CO₂ in the electrolyte at 30 mA g⁻¹ for 30 cycles.

FIG. 19B shows, according to certain embodiments, capacity and Coulombic efficiency for a PW three-electrode cell without EEA-CO₂ in the electrolyte at 30 mA g⁻¹ for 30 cycles.

FIG. 20A shows, according to certain embodiments, charge and discharge curves and for a PW three-electrode cell with EEA-CO₂ in the electrolyte at 30 mA g⁻¹ for 30 cycles.

FIG. 20B shows, according to certain embodiments, capacity and Coulombic efficiency for a PW three-electrode cell with EEA-CO₂ in the electrolyte at 30 mA g⁻¹ for 30 cycles.

FIG. 21A shows, according to certain embodiments, charge and discharge profiles of two-electrode Zn-copper (Cu) cells using 0.50 M potassium bis(trifluoromethanesulfonyl)imide (KTFSI), 0.10 M Zn(TFSI)₂ DMSO electrolyte with 0.0 M EEA-CO₂.

FIG. 21B shows, according to certain embodiments, charge and discharge profiles of two-electrode Zn—Cu cells using 0.50 M KTFSI, 0.10 M Zn(TFSI)₂ DMSO electrolyte with 0.50 M EEA-CO₂.

FIG. 21C shows, according to certain embodiments, a summary of Coulombic efficiencies for 50 cycles.

FIG. 22A shows, according to certain embodiments, gas chromatography (GC) thermal conductivity detector (TCD) signal for the headspace of a Zn/Cu cell and calibration gas containing 0.5% H₂.

FIG. 22B shows, according to certain embodiments, GC flame ionization detector (FID) signal for the headspace of a Zn/Cu cell and calibration gas containing 0.5% hydrogen gas (H₂).

FIG. 23 shows, according to certain embodiments, charge and discharge curves for a PW/Zn full cell with amine at 30, 50, 75, 100, and 125 mA g⁻¹.

### DETAILED DESCRIPTION

Systems and methods related to the separation of carbon dioxide (CO₂) from a fluid source are generally described. According to certain embodiments, an electrochemical system is described that utilizes a dual salt cation-swing process for CO₂ separation at room temperature. In some aspects, the electrochemical system comprises an electrochemical cell that includes: (i) a positive electrode comprising a material that is configured to intercalate a first, relatively weaker Lewis acid cation upon discharge and to de-intercalate the first, relatively weaker Lewis acid cation upon charge; and (ii) a negative electrode comprising a metal that is configured to produce a second, relatively stronger Lewis acid cation upon discharge and to plate the second, relatively stronger Lewis acid cation onto the negative electrode upon charge. In some embodiments, the electrochemical system includes a fluid source comprising an electrolyte salt and a carbamic acid compound.

When the dual salt cell is discharged, the first, relatively weaker Lewis acid cation intercalates into the first electrode, and the second, relatively stronger Lewis acid cation is stripped from the second electrode. The second, relatively stronger Lewis acid cation produced by the second electrode interacts (e.g., associates) with the carbamic acid compound to release CO₂ from the carbamic acid compound, thereby producing ammonium carbamate. In certain aspects, the current is reversed and the dual salt cell is charged, to de-intercalate the first, relatively weaker Lewis acid cation from the first electrode and to plate the second, relatively stronger Lewis acid cation onto the second electrode. The dual salt cell may then be purged with CO₂ to restore the carbamic acid compound, effectively regenerating the electrochemical system prior to discharge.

Conventional thermal-swing amine separations suffer from a high energy penalty (>80 kJ/mol) as well as sorbent degradation and environmental issues that arise from amine exposure to high-temperature steam (120-130° C.) upon regeneration. In addition, conventional electrochemical CO₂ separations are unable to achieve high current rate and low energy consumption simultaneously. By exploiting a reversible carbamic acid-to-carbamate conversion that is induced by changing the identity of the Lewis acid cation in the fluid source, the dual salt cation-swing process can operate at room temperature and achieves a low CO₂ separation energy.

The dual salt cation-swing process may be implemented as a batch process or a continuous flow process (e.g., a flow cell). In certain aspects, the process may be utilized in any of a variety of suitable applications, including, for example, removal of CO₂ from: (i) a flue gas emanating from a power plant; (ii) an emission stream emanating from an industrial process (e.g., cement, ethylene, or other chemical production processes); and/or (iii) an emission stream emanating from a mobile vehicle (e.g., cars, heavy-duty vehicles, etc.). Other applications are also possible.

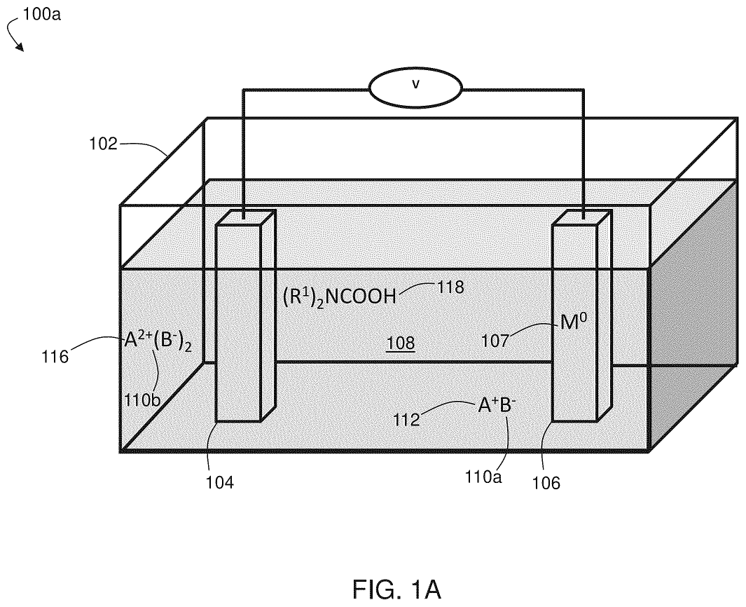

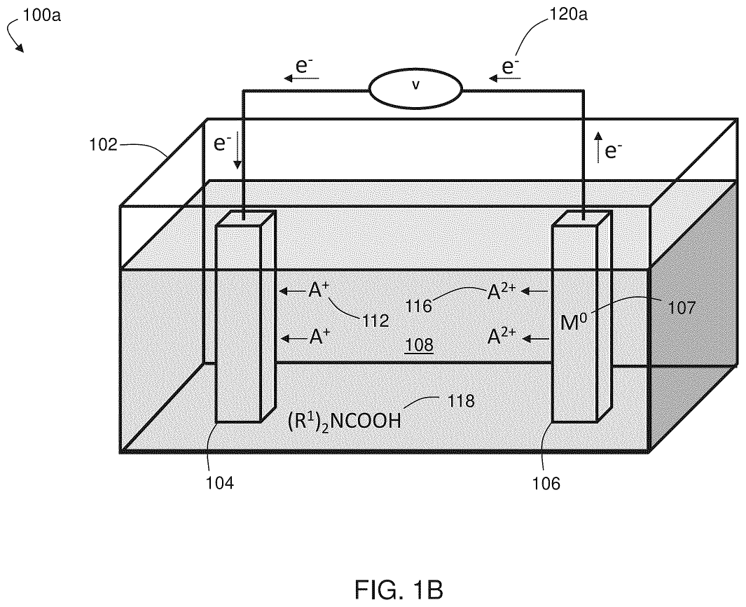

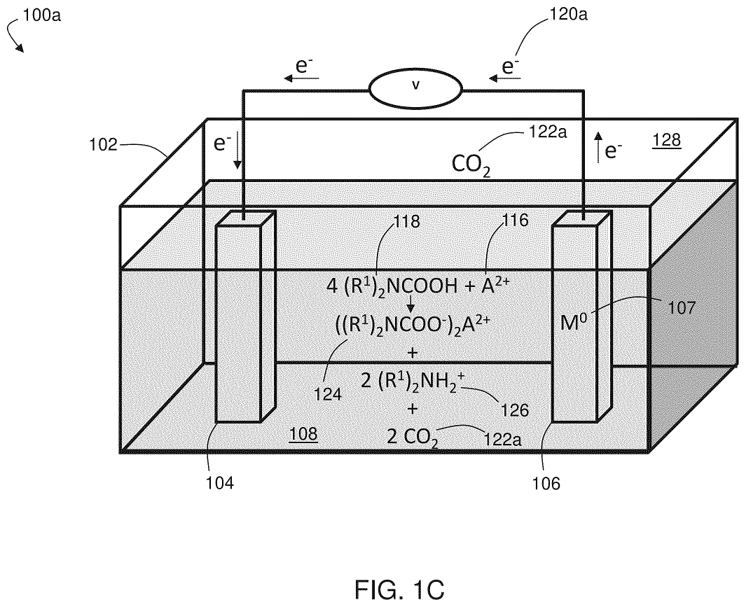

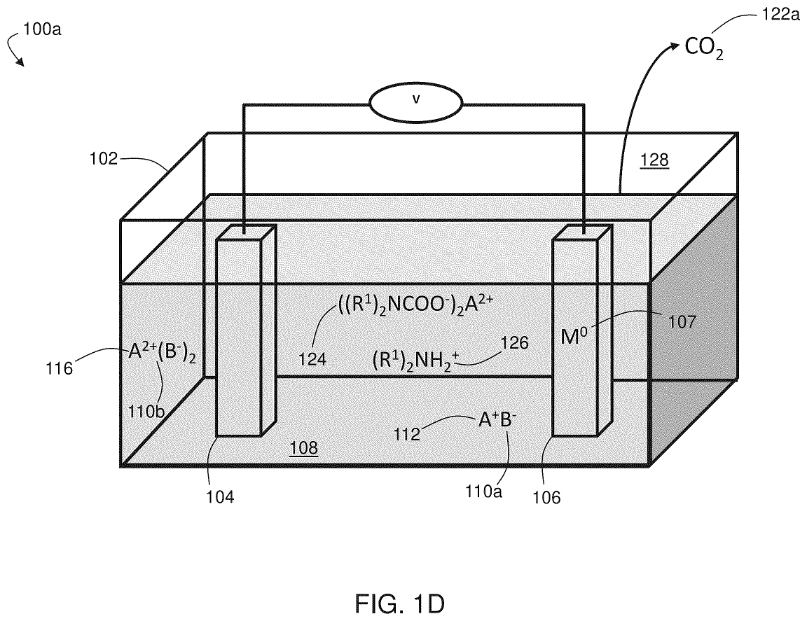

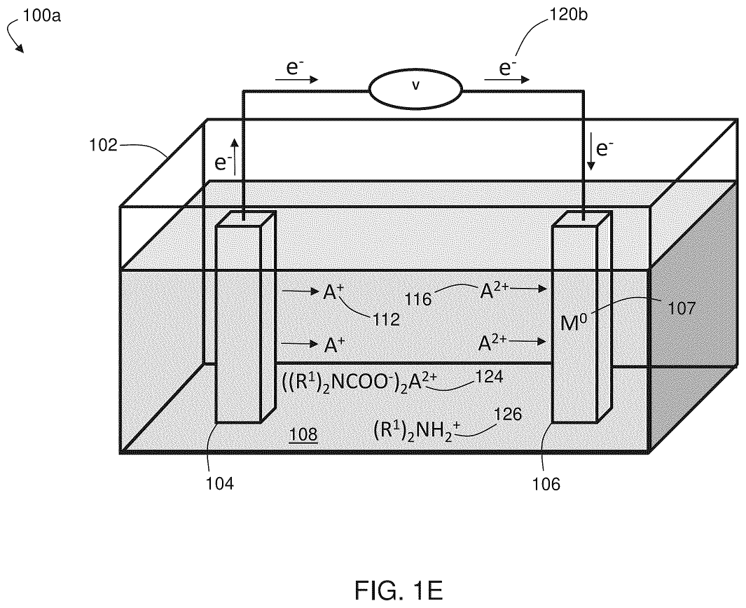

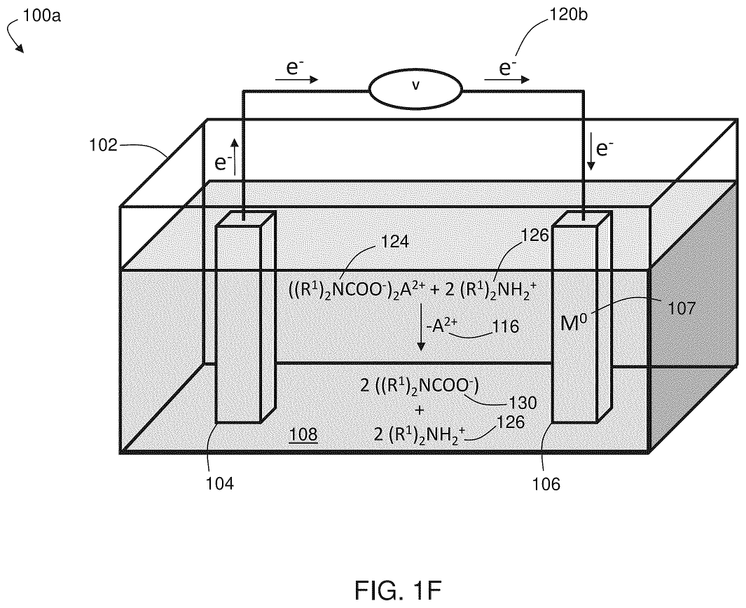

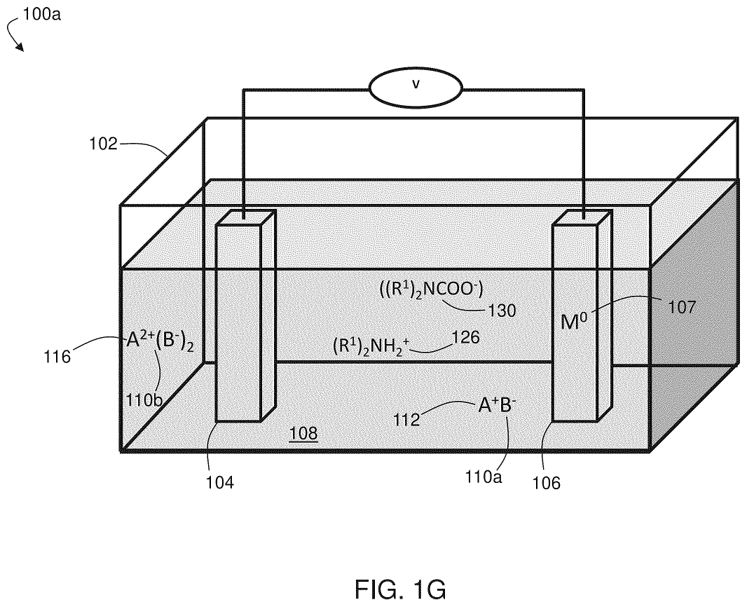

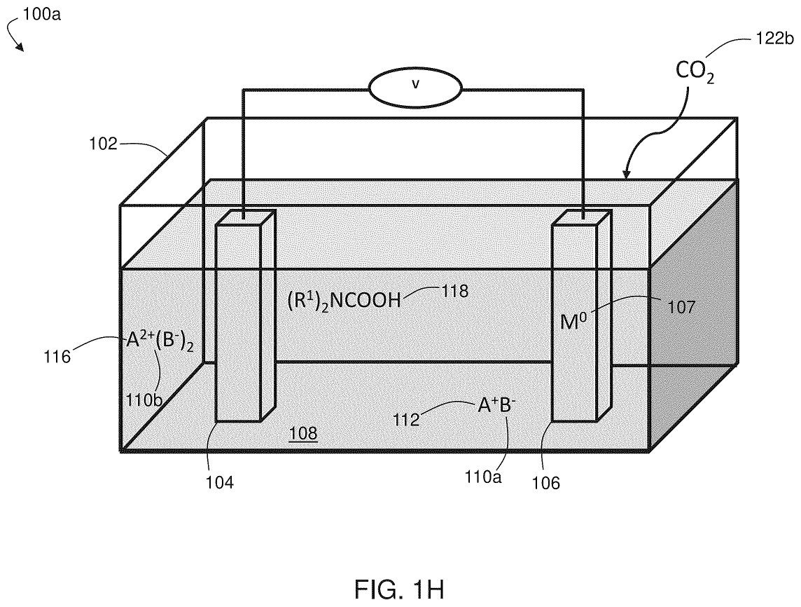

In some embodiments, the electrochemical system comprises an electrochemical cell. FIG. 1A shows a schematic diagram of electrochemical system 100a, in accordance with certain embodiments. As shown in FIG. 1A, electrochemical system 100a comprises electrochemical cell 102.

According to some embodiments, the electrochemical cell comprises a first electrode. Referring to FIG. 1A, for example, electrochemical cell 102 comprises first electrode 104. The first electrode may be a positive electrode. In certain embodiments, for example, during discharge of the electrochemical cell, the positive electrode functions as the cathode (e.g., such that a reduction reaction occurs at the positive electrode). In some embodiments, during charge of the electrochemical cell, the positive electrode functions as the anode (e.g., such that an oxidation reaction occurs at the positive electrode). The first electrode (e.g., positive electrode) may, in certain embodiments, be a working electrode.

The first electrode (e.g., positive electrode) may comprise any of a variety of suitable materials. According to some embodiments, the first electrode is an intercalation electrode such that the first electrode is capable of intercalating one or more ions and/or molecules. As used herein, the term “intercalation” is given its ordinary meaning in the art and generally refers a process by which an ion or molecule is reversibly incorporated into vacant sites in a crystal lattice.

According to some embodiments, the first electrode comprises a material that is capable of intercalating one or more potassium (K), sodium (Na), lithium (Li), and/or cesium (Cs) cations (e.g., K⁺, Na⁺, Li⁺, and/or Cs⁺ cations). In certain embodiments, for example, the first electrode comprises PW, Prussian blue, Prussian blue analogues (PBAs), iron(III) phosphate (FePO₄), KₓMnO₂, and/or K_{0.6}CoO₂. In certain embodiments, Prussian blue and/or the PBAs may comprise iron (Fe), manganese (Mn), nickel (Ni), and the like. Other materials are also possible.

The first electrode (e.g., positive electrode) may have any of a variety of suitable standard reduction potentials. In certain embodiments, for example, the first electrode has a standard reduction potential of greater than or equal to 1 V, greater than or equal to 1.5 V, greater than or equal to 2 V, greater than or equal to 2.5 V, greater than or equal to 3 V, greater than or equal to 3.5 V, greater than or equal to 4 V, or greater than or equal to 4.5 V vs. Li/Li⁺. In some embodiments, the first electrode has a standard reduction potential of less than or equal to 5 V, less than or equal to 4.5 V, less than or equal to 4 V, less than or equal to 3.5 V, less than or equal to 3 V, less than or equal to 2.5 V, less than or equal to 2 V, or less than or equal to 1.5 V vs. Li/Li⁺. Combinations of the above recited ranges are possible (e.g., the first electrode has a standard reduction potential of greater than or equal to 1 V and less than or equal to 5 V vs. Li/Li⁺, the first electrode has a standard reduction potential of greater than or equal to 3 V and less than or equal to 3.5 V vs. Li/Li⁺). Other ranges are also possible.

According to some embodiments, the electrochemical cell comprises a second electrode. Referring to FIG. 1A, for example, electrochemical cell 102 comprises second electrode 106. The second electrode may be a negative electrode, in certain embodiments. In some embodiments, for example, during discharge of the electrochemical cell, the negative electrode functions as the anode (e.g., such that an oxidation reaction occurs at the negative electrode). In certain embodiments, during charge of the electrochemical cell, the negative electrode functions as the cathode (e.g., such that a reduction reaction occurs at the negative electrode). In certain embodiments, the second electrode (e.g., negative electrode) is a counter electrode and/or an auxiliary electrode.

The second electrode (e.g., negative electrode) may comprise any of a variety of suitable materials. In some embodiments, for example, the second electrode comprises a metal. Referring to FIG. 1A, for example, second electrode 106 comprises metal 107, represented as M° in FIG. 1A. Suitable metals include, but are not limited to, Zn, magnesium (Mg), calcium (Ca), and/or combinations thereof.

The second electrode (e.g., negative electrode) may have any of a variety of suitable standard reduction potentials. In certain embodiments, for example, the second electrode has a standard reduction potential of greater than or equal to 0.01 V, greater than or equal to 0.05 V, greater than or equal to 0.1 V, greater than or equal to 0.5 V, greater than or equal to 1 V, greater than or equal to 1.5 V, or greater than or equal to 2 V vs. Li/Li⁺. In some embodiments, the second electrode has a standard reduction potential of less than or equal to 2.5 V, less than or equal to 2 V, less than or equal to 1.5 V, less than or equal to 1 V, less than or equal to 0.5 V, less than or equal to 0.1 V, or less than or equal to 0.05 V vs. Li/Li⁺. Combinations of the above recited ranges are possible (e.g., the second electrode has a standard reduction potential of greater than or equal to 0.01 V and less than or equal to 2.5 V vs. Li/Li⁺, the second electrode has a standard reduction potential of greater than or equal to 0.5 V and less than or equal to 1 V vs. Li/Li⁺). Other ranges are also possible.

In certain embodiments, the standard reduction potential of the second electrode is less than the standard reduction potential of the first electrode.

Although not shown in the figures, the electrochemical cell may, in some embodiments, comprise one or more additional electrodes. In certain embodiments, for example, the electrochemical cell comprises a third electrode (e.g., a reference electrode).

According to some embodiments, the electrochemical system comprises a fluid source. Referring, for example, to FIG. 1A, electrochemical system 100a (e.g., electrochemical cell 102) comprises fluid source 108. The fluid source may comprise any of a variety of suitable fluids (e.g., liquids). In certain embodiments, for example, the fluid source comprises water, a nonaqueous solvent (e.g., an organic solvent), and/or combinations thereof.

According to some embodiments, utilizing a fluid source comprising a nonaqueous solvent may advantageously provide a solution with a higher loading (e.g., a higher concentration) of the carbamic acid compound, as compared to, for example, a fluid source comprising an aqueous solvent. Without wishing to be bound by theory, the nonaqueous solvent may hydrogen bond with and stabilize the carbamic acid compound, as compared to water, which does not stabilize the carbamic acid compound.

Any of a variety of suitable nonaqueous solvents may be employed. In some embodiments, for example, the nonaqueous solvent comprises DMSO, dimethylacetamide (DMA), N-methylpyrrolidone (NMP), and/or combinations thereof. Other nonaqueous solvents are also possible.

According to certain embodiments, the electrochemical system comprises a salt (e.g., a first salt). Referring to FIG. 1A, for example, electrochemical system 100a (e.g., electrochemical cell 102) comprises first salt 110a, represented as A⁺B⁻ in FIG. 1A.

According to certain embodiments, the first salt is an electrolyte salt. In some embodiments, for example, the first salt may be suspended, dispersed, and/or dissolved in the fluid source, such that the combination of the fluid source and the first salt functions, at least in part, as an electrolyte (e.g., a liquid electrolyte) of the electrochemical cell. Referring, for example, to FIG. 1A, first salt 110a is suspended, dispersed, and/or dissolved in fluid source 108.

The first salt (e.g., the first electrolyte salt) may comprise any of a variety of suitable materials. In certain embodiments, for example, the first salt comprises a K-containing salt, a Na-containing salt, a Li-containing salt, a Cs-containing salt, and/or combinations thereof. Suitable first salts include, but are not limited to, K⁺, Na⁺, Li⁺, and/or Cs⁺ salts of a bis(trifluoromethanesulfonyl)imide anion (TFSI⁻), a tetrafluoroborate anion (BF₄⁻), a perchlorate anion (ClO₄⁻), a hexafluorophosphate anion (PF₆⁻), a bis(fluorosulfonyl)imide anion (FSI⁻), a nitrate anion (NO₃⁻), and/or combinations thereof.

In certain embodiments, the first salt comprises a first Lewis acid cation. Referring to FIG. 1A, for example, first salt 110a comprises first Lewis acid cation 112, represented as A⁺ in FIG. 1A. As used herein, the term “Lewis acid” is given its ordinary meaning in the art and generally refers to a chemical species that contains an empty orbital which is capable of accepting an electron pair from a Lewis base to form a Lewis adduct. The term “Lewis base”, as used herein, is given its ordinary meaning in the art and generally refers to a chemical species that has a filled orbital containing an electron pair which is not involved in bonding but may form a dative bond with a Lewis acid to form a Lewis adduct.

The first salt may comprise any of a variety of suitable first Lewis acid cations. According to certain embodiments, the first Lewis acid cation is monocationic. In certain embodiments, for example, the first Lewis acid cation is K⁺, Na⁺, Li⁺, Cs⁺, and/or combinations thereof. Other first Lewis acid cations are also possible.

According to some embodiments, the electrochemical system comprises a second salt. The second salt may, in some embodiments, be different than the first salt. Referring to FIG. 1A, for example, electrochemical system 100a (e.g., electrochemical cell 102) comprises second salt 110b, represented as A²⁺(B⁻)₂ in FIG. 1A.

According to certain embodiments, the second salt is an electrolyte salt. In some embodiments, for example, the second salt may be suspended, dispersed, and/or dissolved in the fluid source, such that the combination of the fluid source and the second salt functions, at least in part, as an electrolyte (e.g., a liquid electrolyte) of the electrochemical cell. Referring, for example, to FIG. 1A, second salt 110b is suspended, dispersed, and/or dissolved in fluid source 108.

The second salt (e.g., the second electrolyte salt) may comprise any of a variety of suitable materials. In certain embodiments, for example, the second salt comprises a Zn-containing salt, a Mg-containing salt, a Ca-containing salt, and/or combinations thereof. Suitable second salts include, but are not limited to, Zn²⁺, Mg²⁺, and/or Ca²⁺ salts of TFSI⁻, BF₄⁻, ClO₄⁻, PF₆⁻, FSI⁻, NO₃⁻, and/or combinations thereof.

In certain embodiments, the second salt comprises a second Lewis acid cation. Referring to FIG. 1A, for example, second salt 110b comprises second Lewis acid cation 116, represented as A²⁺ in FIG. 1A.

The second salt may comprise any of a variety of suitable second Lewis acid cations. According to certain embodiments, the second Lewis acid cation is dicationic. In certain embodiments, for example, the second Lewis acid cation is Zn²⁺, Mg²⁺, Ca²⁺, and/or combinations thereof. Other second Lewis acid cations are also possible.

According to certain embodiments, the second Lewis acid cation is a stronger Lewis acid than the first Lewis acid cation. As would be understood by a person of ordinary skill in the art, the strength of a Lewis acid cation may be determined by a number of factors including: (i) the positive charge of the metal ion, wherein a higher positive charge indicates a stronger Lewis acid; (ii) the atomic radius of the metal ion, wherein a smaller atomic radius indicates a stronger Lewis acid; and (iii) the electronegativity of the metal ion, wherein a more electronegative metal ion indicates a stronger Lewis acid.

According to certain embodiments, the electrochemical system comprises a carbamic acid compound. Referring, for example, to FIG. 1A, electrochemical system 100a (e.g., electrochemical cell 102) comprises carbamic acid compound 118, represented as (R¹)₂NCOOH in FIG. 1A. Suitable carbamic acid compounds are those that include carbamic acid, and also include other components rendering the compound able to interact with a Lewis acid cation produced in an electrochemical cell as described herein, to release CO₂. Those of ordinary skill in the art, with the benefit of this disclosure, including but not limited to the disclosure's description of the electrochemical cell, electrodes, Lewis acids of various strengths, etc., will be able to formulate suitable carbamic acid compounds.

In some embodiments, the carbamic acid compound may be suspended, dispersed, and/or dissolved in the fluid source. Referring to FIG. 1A, for example, carbamic acid compound 118 is suspended, dispersed, and/or dissolved in fluid source 108.

In some embodiments, the carbamic acid compound is a compound of the formula (R¹)₂NCOOH. In certain embodiments, each R¹ is the same or different and is selected from the group consisting of hydrogen, deuterium, —C₁-C₁₀ alkyl, —C₂-C₁₀ alkenyl, —C₃-C₁₀ alkynyl, —C₃-C₁₀ cycloalkyl, and —R²—O—R². According to some embodiments, each R² is the same or different and is selected from the group consisting of hydrogen, deuterium, —C₁-C₁₀ alkyl, —C₂-C₁₀ alkenyl, —C₃-C₁₀ alkynyl, and —C₃-C₁₀ cycloalkyl.

Any of a variety of suitable carbamic acid compounds may be employed. According to some embodiments, the carbamic acid compound is chosen by a person of ordinary skill in the art such that the carbamic acid compound is at least partially soluble in the fluid source. The carbamic acid compound may, in some embodiments, comprise a primary amine, a secondary amine, or a cyclic amine that is configured to stabilize the carbamic acid compound. In certain embodiments, for example, the carbamic acid compound comprises carbamic acid, (2-methoxyethyl)carbamic acid, (2-ethoxyethyl)carbamic acid, and/or combinations thereof. Other carbamic acid compounds are also possible.

The concentration of the carbamic acid compound in the fluid source may be any of a variety of suitable values. In some embodiments, for example, the concentration of the carbamic acid compound in the fluid source is greater than or equal to 0.1 M, greater than or equal to 0.5 M, greater than or equal to 1 M, greater than or equal to 1.5 M, greater than or equal to 2 M, greater than or equal to 2.5 M, greater than or equal to 3 M, greater than or equal to 3.5 M, greater than or equal to 4 M, or greater than or equal to 4.5 M. In certain embodiments, the concentration of the carbamic acid compound in the fluid source is less than or equal to 5 M, less than or equal to 4.5 M, less than or equal to 4 M, less than or equal to 3.5 M, less than or equal to 3 M, less than or equal to 2.5 M, less than or equal to 2 M, less than or equal to 1.5 M, less than or equal to 1 M, or less than or equal to 0.5 M. Combinations of the above recited ranges are possible (e.g., the concentration of the carbamic acid compound in the fluid source is greater than or equal to 0.1 M and less than or equal to 5 M, the concentration of the carbamic acid compound in the fluid source is greater than or equal to 2 M and less than or equal to 3 M). Other ranges are also possible.

Although not shown in the figures, the electrochemical system (e.g., electrochemical cell) comprises a separator, in accordance with certain embodiments. The separator may, in some embodiments, be located between the first electrode (e.g., the positive electrode) and the second electrode (e.g., the negative electrode). The separator may be configured to inhibit (e.g., prevent) physical contact between the first electrode and the second electrode, which could result in short circuiting of the electrochemical cell. In certain embodiments, the separator may separate the first electrode and the second electrode such that the electrochemical cell comprises a first chamber (e.g., a first electrode chamber (positive electrode chamber)) and a second chamber (e.g., a second electrode chamber (negative electrode chamber)). The separator may be configured to be substantially electronically non-conductive, which can inhibit the degree to which the separator causes short circuiting of the electrochemical cell.

The separator may comprise any of a variety of materials. In some embodiments, the separator may be at least partially porous. In certain embodiments, for example, the separator comprises a polymeric material (e.g., a polymeric material that does not swell upon exposure to the fluid source) or glass fiber. In certain embodiments, the separator may be a dense or an essentially non-porous material. For example, in some embodiments, the separator may comprise a cation (e.g., Li⁺) conductor, such as lithium aluminum germanium phosphate (LAGP), lithium lanthanum zirconium oxide (LLZO), and/or the like.

According to certain embodiments, upon discharge of the electrochemical cell, the first electrode (e.g., positive electrode) is configured to intercalate the first Lewis acid cation. FIG. 1B shows, according to certain embodiments, a schematic diagram of electrochemical system 100a during discharge of electrochemical cell 102. First salt 110a and second salt 110b have been removed from FIG. 1B for clarity. As shown in FIG. 1B, upon discharge of electrochemical cell 102 (represented by flow 120a of electrons), first electrode 104 is configured to intercalate first Lewis acid cation 112.

In some embodiments, upon discharge of the electrochemical cell, the second electrode is configured to produce a second Lewis acid cation. Referring, for example, to FIG. 1B, upon discharge of electrochemical cell 102 (represented by flow 120a of electrons), second electrode 106 is configured to produce second Lewis acid cation 116. In some embodiments, the metal of the second electrode may be oxidized to a cationic oxidation state as the second electrode produces the second Lewis acid cation. Referring to FIG. 1B, for example, metal 107 of second electrode 106, represented as M⁰ in FIG. 1B, may be oxidized to a cationic oxidation state as second electrode 106 produces second Lewis acid cation 116.

The second Lewis acid cation produced by the second electrode of the electrochemical cell during discharge of the electrochemical cell may be any of the second Lewis acid cations described herein with respect to the second salt. In certain embodiments, for example, the second Lewis acid cation produced by the second electrode of the electrochemical cell during discharge of the electrochemical cell is Zn²⁺, Mg²⁺, Ca²⁺, and/or combinations thereof.

According to certain embodiments, the second Lewis acid cation produced by the second electrode of the electrochemical cell during discharge of the electrochemical cell is configured to interact (e.g., associate) with the carbamic acid compound to release CO₂ from the carbamic acid compound. FIG. 1C shows, according to certain embodiments, a schematic diagram of electrochemical system 100a during discharge of electrochemical cell 102 (represented by flow 120a of electrons), wherein second Lewis acid cation 116 has interacted with carbamic acid compound 118 to release CO₂ 122a from carbamic acid compound 118. First salt 110a and second salt 110b have been removed from FIG. 1C for clarity.

In some embodiments, the second Lewis acid cation is configured to interact with the carbamic acid compound to release CO₂ from the carbamic acid compound by destabilizing an interaction between an oxygen and a proton of the carbamic acid compound (e.g., the (R¹)₂NCOOH compound). In accordance with certain embodiments, destabilizing the interaction between an oxygen and a proton of the carbamic acid compound generates CO₂, an ammonium compound of the formula (R¹)₂NH₂⁺, and a carbamate compound of the formula (R¹)₂NCOO⁻, wherein each R¹ in the ammonium compound and/or the carbamate compound is the same or different and is selected from the group consisting of hydrogen, deuterium, —C₁-C₁₀ alkyl, —C₂-C₁₀ alkenyl, —C₃-C₁₀ alkynyl, —C₃-C₁₀ cycloalkyl, and —R²—O—R², and each R² is the same or different and is selected from the group consisting of hydrogen, deuterium, —C₁-C₁₀ alkyl, —C₂-C₁₀ alkenyl, —C₃-C₁₀ alkynyl, and —C₃-C₁₀ cycloalkyl. In certain embodiments, the second Lewis acid cation and the carbamate compound of the formula (R¹)₂NCOO⁻ may form an adduct (e.g., a carbamate compound-second Lewis acid cation adduct). Referring to FIG. 1C, for example, destabilizing the interaction between an oxygen and a proton of carbamic acid compound 118 generates CO₂ 122a, adduct 124, and ammonium compound 126. In certain embodiments, the interaction between the second Lewis acid cation and the carbamate compound in the carbamate compound-second Lewis acid cation adduct is an electrostatic interaction.

In certain embodiments, and as shown in FIG. 1C, the balanced chemical reaction taking place within electrochemical system 100a (e.g., within electrochemical cell 102) during discharge of electrochemical cell 102 may be represented as the following:

$$4 {( {R}^{1} )}_{2} NCOOH + {A}^{2 +} \to {( {( {R}^{1} )}_{2} {NCOO}^{-} )}_{2} {A}^{2 +} + 2 {( {R}^{1} )}_{2} {NH}_{2}^{+} + 2 {CO}_{2} ,$$

wherein each R¹ is the same or different and is selected from the group consisting of hydrogen, deuterium, —C₁-C₁₀ alkyl, —C₂-C₁₀ alkenyl, —C₃-C₁₀ alkynyl, —C₃-C₁₀ cycloalkyl, and —R²—O—R², and each R² is the same or different and is selected from the group consisting of hydrogen, deuterium, —C₁-C₁₀ alkyl, —C₂-C₁₀ alkenyl, —C₃-C₁₀ alkynyl, and —C₃-C₁₀ cycloalkyl.

According to certain embodiments, the adduct (e.g., the carbamate compound-second Lewis acid cation adduct), the ammonium compound, and the CO₂ may be at least partially suspended, dispersed, and/or dissolved in the fluid source. Referring to FIG. 1C, for example, adduct 124, ammonium compound 126, and CO₂ 122a may be at least partially suspended, dispersed, and/or dissolved in fluid source 108.

As would be understood by a person of ordinary skill in the art, the CO₂ released from the carbamic acid compound may be in the gaseous state. In certain embodiments, the CO₂ released from the carbamic acid compound may be a gas dissolved in the fluid source. Referring to FIG. 1C, for example, the CO₂ released from carbamic acid compound 118 may be a gas dissolved in fluid source 108.

In some embodiments, the CO₂ may be at least partially separated from the fluid source. In certain embodiments, for example, the CO₂ may be at least partially in a gaseous atmosphere of the electrochemical system. Referring to FIG. 1C, for example, CO₂ 122a may be at least partially separated from fluid source 108 and may be at least partially in gaseous atmosphere 128 of electrochemical system 100a. In some embodiments, for example, CO₂ 122a may be at least partially in a headspace of electrochemical cell 102. As explained herein, the CO₂ may be released from the carbamic acid compound may be a gas dissolved in the fluid source, in accordance with some embodiments. In certain embodiments, once the fluid source reaches its saturation limit for the CO₂, the CO₂ may be forced into the headspace of the electrochemical cell.

FIG. 1D shows, according to certain embodiments, a schematic diagram of electrochemical system 100a after discharge of electrochemical cell 102. As shown in FIG. 1D, after discharge of electrochemical cell 102, electrochemical system 100a (e.g., electrochemical cell 102) may comprise first electrode 104 comprising a first Lewis acid cation intercalated into first electrode 104, second electrode 106, fluid source 108, first salt 110a, second salt 110b, adduct 124 (e.g., carbamate compound-second Lewis acid cation adduct), and ammonium compound 126. As explained herein in greater detail, first salt 110a, second salt 110b, adduct 124, and ammonium compound 126 may be at least partially suspended, dispersed, and/or dissolved in fluid source 108.

In some embodiments, after discharge of the electrochemical cell, the CO₂ may be removed from the electrochemical system. Referring to FIG. 1D, for example, after discharge of electrochemical cell 102, CO₂ 122a may be removed from electrochemical system 100a. Configurations for and methods of removing CO₂ from the electrochemical system are explained in greater detail below.

According to certain embodiments, upon charge of the electrochemical cell, the first electrode (e.g., positive electrode) is configured to de-intercalate the first Lewis acid cation. FIG. 1E shows, according to certain embodiments, a schematic diagram of the electrochemical system of FIG. 1A during charge of electrochemical cell 102. First salt 110a and second salt 110b have been removed from FIG. 1E for clarity. As shown in FIG. 1E, upon charge of electrochemical cell 102 (represented by flow 120b of electrons), first electrode 104 is configured to de-intercalate first Lewis acid cation 112.

In some embodiments, upon charge of the electrochemical cell, the second Lewis acid cation is configured to plate onto the second electrode. Referring, for example, to FIG. 1E, upon charge of electrochemical cell 102 (represented by flow 120b of electrons), second Lewis acid cation 116 is configured to plate onto second electrode 106. The second Lewis acid cation may be reduced to a metal (e.g., a neutral metal) of the second electrode as the second Lewis acid cation plates onto the second electrode, in certain embodiments. Referring to FIG. 1E, for example, second Lewis acid cation 116 may be reduced to metal 107 of second electrode 106, represented as M⁰ in FIG. 1E, as second Lewis acid cation 116 plates onto second electrode 106.

According to certain embodiments, upon charge of the electrochemical cell, the second Lewis acid cation of the adduct (e.g., the carbamate compound-second Lewis acid cation adduct) is configured to de-interact (e.g., disassociate) from the adduct and plate onto the second electrode. FIG. 1F shows, according to certain embodiments, a schematic diagram of electrochemical system 100a during charge of electrochemical cell 102 (represented by flow 120b of electrons), wherein second Lewis acid cation 116 of adduct 124 has de-interacted (e.g., disassociated) from adduct 124 and plated onto second electrode 116 (as shown, for example, in FIG. 1E). First salt 110a and second salt 110b have been removed from FIG. 1F for clarity.

In some embodiments, the second Lewis acid cation de-interacting (e.g., disassociating) with the adduct (e.g., the carbamate compound-second Lewis acid cation) generates a carbamate compound of the formula (R¹)₂NCOO⁻ and an ammonium compound of the formula (R¹)₂NH₂⁺, wherein each R¹ is the same or different and is selected from the group consisting of hydrogen, deuterium, —C₁-C₁₀ alkyl, —C₂-C₁₀ alkenyl, —C₃-C₁₀ alkynyl, —C₃-C₁₀ cycloalkyl, and —R²—O—R², and each R² is the same or different and is selected from the group consisting of hydrogen, deuterium, —C₁-C₁₀ alkyl, —C₂-C₁₀ alkenyl, —C₃-C₁₀ alkynyl, and —C₃-C₁₀ cycloalkyl. Referring to FIG. 1F, for example, the second Lewis acid cation de-interacting (e.g., disassociating) with adduct 124 generates carbamate compound 130 and ammonium compound 126.

In certain embodiments, and as shown in FIG. 1F, the balanced chemical reaction taking place within electrochemical system 100a (e.g., electrochemical cell 102) during charge of electrochemical cell 102 may be represented as the following:

$${( {( {R}^{1} )}_{2} {NCOO}^{-} )}_{2} {A}^{2 +} - {A}^{2 +} + 2 {( {R}^{1} )}_{2} {NH}_{2}^{+} \to 2 ( {( {R}^{1} )}_{2} {NCOO}^{-} ) + 2 {( {R}^{1} )}_{2} {NH}_{2}^{+} ,$$

wherein each R¹ is the same or different and is selected from the group consisting of hydrogen, deuterium, —C₁-C₁₀ alkyl, —C₂-C₁₀ alkenyl, —C₃-C₁₀ alkynyl, —C₃-C₁₀ cycloalkyl, and —R²—O—R², and each R² is the same or different and is selected from the group consisting of hydrogen, deuterium, —C₁-C₁₀ alkyl, —C₂-C₁₀ alkenyl, —C₃-C₁₀ alkynyl, and —C₃-C₁₀ cycloalkyl.

According to certain embodiments, the carbamate compound and the ammonium compound may be at least partially suspended, dispersed, and/or dissolved in the fluid source. Referring to FIG. 1F, for example, carbamate compound 130 and ammonium compound 126 may be at least partially suspended, dispersed, and/or dissolved in fluid source 108.

FIG. 1G shows, according to certain embodiments, a schematic diagram of electrochemical system 100a after charge of electrochemical cell 102. As shown in FIG. 1G, after charge of electrochemical cell 102, electrochemical system 100a (e.g., electrochemical cell 102) may comprise first electrode 104, second electrode 106, fluid source 108, first salt 110a, second salt 110b, carbamate compound 130, and ammonium compound 126. As explained herein in greater detail, first salt 110a, second salt 110b, carbamate compound 130, and ammonium compound 126 may be at least partially suspended, dispersed, and/or dissolved in fluid source 108.

FIG. 1H shows, according to certain embodiments, a schematic diagram of electrochemical system 100a after charge of electrochemical cell 102, wherein the fluid source has been purged with CO₂. As shown in FIG. 1H, after charge of electrochemical cell 102, fluid source 108 may be purged with CO₂ 122b. According to certain embodiments, upon purging the fluid source with CO₂, the CO₂ regenerates the carbamic acid compound. Referring to FIG. 1H, for example, upon purging fluid source 108 with CO₂ 122b, CO₂ 122b regenerates carbamic acid compound 118. Configurations for and methods of purging the fluid source with CO₂ are explained in greater detail below.

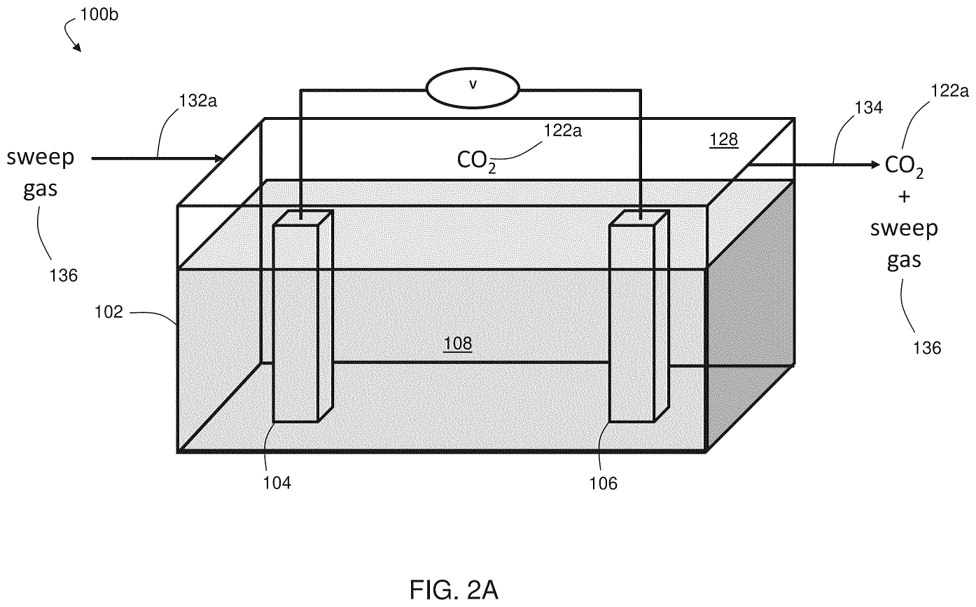

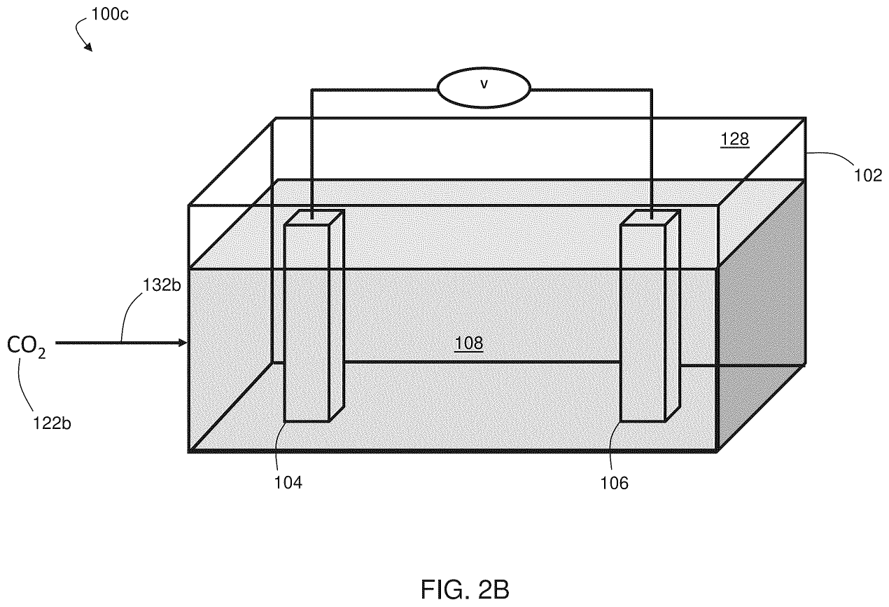

According to certain embodiments, the electrochemical system may comprise one or more fluidic connections fluidically connected to the electrochemical cell. FIG. 2A shows, according to certain embodiments, a schematic diagram of electrochemical system 100b comprising one or more fluidic connections fluidically connected to electrochemical cell 102. In certain embodiments, the one or more fluidic connections may comprise an inlet and/or an outlet fluidically connected to the electrochemical cell. Referring, for example, to FIG. 2A, electrochemical system 100b comprises inlet 132a and outlet 134 fluidically connected to electrochemical cell 102. In some embodiments, the one or more fluidic connections may be fluidically connected to a gaseous atmosphere of the electrochemical system. As shown in FIG. 2A, for example, inlet 132a and outlet 134 are fluidically connected to gaseous atmosphere 128 of electrochemical system 100b. In some embodiments, for example, inlet 132a and outlet 134 are fluidically connected to a headspace of electrochemical cell 102.

In some embodiments, the one or more fluidic connections may be configured to remove CO₂ from the electrochemical system after discharge of the electrochemical cell. In certain embodiments, for example, CO₂ may be released from the carbamic acid compound upon discharge of the electrochemical cell, and after discharge of the electrochemical cell, the released CO₂ may be at least partially separated from the fluid source and may be at least partially in a gaseous atmosphere of the electrochemical system (e.g., as explained herein in greater detail with respect to FIG. 1C). As shown in FIG. 2A, outlet 134 may be configured to remove CO₂ 122a from electrochemical system 100b (e.g., from gaseous atmosphere 128 of electrochemical system 100b) after discharge of electrochemical cell 102.

According to certain embodiments, the one or more fluidic connections may be configured to remove CO₂ from the electrochemical system using a sweep gas. As shown in FIG. 2A, for example, outlet 134 may be configured to remove CO₂ 122a from electrochemical system 100b (e.g., from gaseous atmosphere 128 of electrochemical system 100b) by flowing sweep gas 136 through inlet 132a, through gaseous atmosphere 128 of electrochemical system 100b, and through outlet 134.

Any of a variety of sweep gases may be utilized to remove CO₂ from the electrochemical system. In certain embodiments, the sweep gas is an inert gas. In some embodiments, for example, the sweep gas comprises dinitrogen (N₂), argon (Ar), and/or combinations thereof. Other sweep gases are also possible.

According to some embodiments, the CO₂ may be removed from the mixture of CO₂ and sweep gas. In certain embodiments, for example, the mixture of CO₂ and sweep gas may be flowed to a CO₂ absorption unit to remove CO₂ from the mixture of CO₂ and sweep gas.

In some embodiments, the one or more fluidic connections may be configured to introduce CO₂ into the electrochemical system after charge of the electrochemical cell. In certain embodiments, for example, after charge of the electrochemical cell, the electrochemical cell may comprise a carbamate compound and an ammonium compound (e.g., as explained herein in greater detail with respect to FIG. 1G), and the fluid source may be purged with CO₂ to regenerate the carbamic acid compound (e.g., as explained herein in greater detail with respect to FIG. 1H). FIG. 2B shows, according to certain embodiments, a schematic diagram of electrochemical system 100c comprising inlet 132b for introducing CO₂ 122b into electrochemical system 100c after charge of electrochemical cell 102.

In some embodiments, the one or more fluidic connections may be fluidically connected to the fluid source of the electrochemical system. Referring to FIG. 2B, for example, inlet 132b is fluidically connected to fluid source 108 of electrochemical system 100c such that CO₂ 122b may be purged directly into fluid source 108.

The CO₂ introduced into the electrochemical system may be pure CO₂ or dilute CO₂, according to certain embodiments. In some embodiments, for example, a pure stream of CO₂ is introduced into the electrochemical system via the one or more fluidic connections. In other embodiments, a flue gas (e.g., from a combustion plant) comprising CO₂ and one or more other gases (e.g., nitrogen, air, water, oxygen, etc.) may be introduced into the electrochemical system via the one or more fluidic connections.

According to certain embodiments, a method of releasing CO₂ (e.g., from a carbamic acid compound) is described. In some embodiments, the method comprises providing an electrochemical cell in a fluid source. Referring, for example to FIG. 1A, the method comprises providing electrochemical cell 102 in fluid source 108. The fluid source may comprise any of the fluids (e.g., liquids) previously described herein (e.g., water, a nonaqueous solvent such as DMSO, DMA, NMP, and/or combinations thereof).

In some embodiments, the electrochemical cell comprises a first electrode (e.g., a positive electrode) and a second electrode (e.g., a negative electrode). Referring to FIG. 1A, for example, electrochemical cell 102 comprises first electrode 104 and second electrode 106. The first electrode may comprise any of the materials previously described herein (e.g., a material capable of intercalating one or more K⁺, Na⁺, Li⁺, and/or Cs⁺ cations), and the second electrode may comprise any of the materials previously described herein (e.g., Zn, Mg, Ca, and/or combinations thereof).

According to some embodiments, the fluid source comprises a first salt (e.g., a first electrolyte salt). Referring to FIG. 1A, for example, fluid source 108 comprises first salt 110a. First salt 110a may, in some embodiments, comprise first Lewis acid cation 112. The first salt may comprise any of the salts previously described herein (e.g., a K-containing salt, a Na-containing salt, a Li-containing salt, a Cs-containing salt, and/or combinations thereof).

In some embodiments, the fluid source comprises a second salt (e.g., a second electrolyte salt). Referring to FIG. 1A, for example, fluid source 108 comprises second salt 110b. Second salt 110b may, in some embodiments, comprise second Lewis acid cation 116. The second salt may comprise of the second salts previously described herein (e.g., a Zn-containing salt, a Mg-containing salt, a Ca-containing salt, and/or combinations thereof).

In certain embodiments, the fluid source comprises a carbamic acid compound. Referring to FIG. 1A, for example, fluid source 108 comprises carbamic acid compound 118 (e.g., a compound of the formula (R¹)₂NCOOH, wherein each R¹ is the same or different and is selected from the group consisting of hydrogen, deuterium, —C₁-C₁₀ alkyl, —C₂-C₁₀ alkenyl, —C₃-C₁₀ alkynyl, —C₃-C₁₀ cycloalkyl, and —R²—O—R², and each R² is the same or different and is selected from the group consisting of hydrogen, deuterium, —C₁-C₁₀ alkyl, —C₂-C₁₀ alkenyl, —C₃-C₁₀ alkynyl, and —C₃-C₁₀ cycloalkyl, as previously described herein).

According to some embodiments, the carbamic acid compound may be generated in the fluid source. In some embodiments, for example, the fluid source may comprise a carbamate compound, (e.g., of the formula (R¹)₂NCOO⁻, wherein each R¹ is the same or different and is selected from the group consisting of hydrogen, deuterium, —C₁-C₁₀ alkyl, —C₂-C₁₀ alkenyl, —C₃-C₁₀ alkynyl, —C₃-C₁₀ cycloalkyl, and —R²—O—R², and each R² is the same or different and is selected from the group consisting of hydrogen, deuterium, —C₁-C₁₀ alkyl, —C₂-C₁₀ alkenyl, —C₃-C₁₀ alkynyl, and —C₃-C₁₀ cycloalkyl), and the fluid source may be purged with CO₂ to generate the carbamic acid compound.

Providing the electrochemical cell in the fluid source may occur at any of a variety of temperatures. In certain embodiments, for example, the providing occurs at a temperature greater than or equal to 0° C., greater than or equal to 10° C., greater than or equal to 15° C., greater than or equal to 20° C., greater than or equal to 25° C., greater than or equal to 30° C., greater than or equal to 35° C., greater than or equal to 40° C., greater than or equal to 45° C., greater than or equal to 50° C., greater than or equal to 55° C., greater than or equal to 60° C., greater than or equal to 65° C., greater than or equal to 70° C., greater than or equal to 75° C., greater than or equal to 80° C., greater than or equal to 85° C., greater than or equal to 90° C., or greater than or equal to 95° C. In some embodiments, the providing occurs at a temperature less than or equal to 100° C., less than or equal to 95° C., less than or equal to 90° C., less than or equal to 85° C., less than or equal to 80° C., less than or equal to 75° C., less than or equal to 70° C., less than or equal to 65° C., less than or equal to 60° C., less than or equal to 55° C., less than or equal to 50° C., less than or equal to 45° C., less than or equal to 40° C., less than or equal to 35° C., less than or equal to 30° C., less than or equal to 25° C., less than or equal to 20° C., less than or equal to 15° C., less than or equal to 10° C., or less than or equal to 5° C. Combinations of the above recited ranges are possible (e.g., the providing occurs at a temperature greater than or equal to 0° C. and less than or equal to 100° C., the providing occurs at a temperature greater than or equal to 20° C. and less than or equal to 25° C.). Other ranges are also possible.

In certain embodiments, the providing occurs at room temperature (e.g., greater than or equal to 20° C. and less than or equal to 25° C., greater than or equal to 20° C. and less than or equal to 22° C.).

According to certain embodiments, the method comprises discharging the electrochemical cell. Referring to FIG. 1B, for example, the method comprises discharging electrochemical cell 102 (represented by flow 120a of electrons).

In certain embodiments, the discharging is performed in the presence of the first Lewis acid cation. Referring, for example, to FIG. 1B, discharging electrochemical cell 102 is performed in the presence of first Lewis acid cation 112, such that first Lewis acid cation 112 is suspended, dispersed, and/or dissolved in fluid source 108 during the discharging.

In some embodiments, the discharging comprises intercalating the first Lewis acid cation into the first electrode (e.g., the positive electrode) of the electrochemical cell. Referring, for example, to FIG. 1B, discharging comprises intercalating first Lewis acid cation 112 into first electrode 104 of electrochemical cell 102.

According to some embodiments, the discharging comprises producing a second Lewis acid cation from the second electrode (e.g., the negative electrode) of the electrochemical cell. Referring to FIG. 1B, for example, discharging comprises producing second Lewis acid cation 116 from second electrode 106 of electrochemical cell 102.

In some embodiments, as a result of the discharging, the second Lewis acid cation interacts with the carbamic acid compound and releases CO₂ from the carbamic acid compound. Referring to FIG. 1C, for example, second Lewis acid cation 116 interacts with carbamic acid compound 118 and releases CO₂ 122a from carbamic acid compound 118 as a result of the discharging. In certain embodiments, as a result of the discharging, the second Lewis acid cation destabilizes an interaction between the oxygen and the proton of the carbamic acid compound and generates an ammonium compound and a carbamate compound-second Lewis acid cation adduct. Referring to FIG. 1C, for example, second Lewis acid cation 116 destabilizes an interaction between the oxygen and the proton of carbamic acid compound 118 and generates ammonium compound 126 and adduct 124.

Discharging the electrochemical cell may occur at any of a variety of temperatures. In certain embodiments, for example, the discharging occurs at a temperature greater than or equal to 0° C., greater than or equal to 10° C., greater than or equal to 15° C., greater than or equal to 20° C., greater than or equal to 25° C., greater than or equal to 30° C., greater than or equal to 35° C., greater than or equal to 40° C., greater than or equal to 45° C., greater than or equal to 50° C., greater than or equal to 55° C., greater than or equal to 60° C., greater than or equal to 65° C., greater than or equal to 70° C., greater than or equal to 75° C., greater than or equal to 80° C., greater than or equal to 85° C., greater than or equal to 90° C., or greater than or equal to 95° C. In some embodiments, the discharging occurs at a temperature less than or equal to 100° C., less than or equal to 95° C., less than or equal to 90° C., less than or equal to 85° C., less than or equal to 80° C., less than or equal to 75° C., less than or equal to 70° C., less than or equal to 65° C., less than or equal to 60° C., less than or equal to 55° C., less than or equal to 50° C., less than or equal to 45° C., less than or equal to 40° C., less than or equal to 35° C., less than or equal to 30° C., less than or equal to 25° C., less than or equal to 20° C., less than or equal to 15° C., less than or equal to 10° C., or less than or equal to 5° C. Combinations of the above recited ranges are possible (e.g., the discharging occurs at a temperature greater than or equal to 0° C. and less than or equal to 100° C., the discharging occurs at a temperature greater than or equal to 20° C. and less than or equal to 25° C.). Other ranges are also possible.

In certain embodiments, the discharging occurs at room temperature (e.g., greater than or equal to 20° C. and less than or equal to 25° C., greater than or equal to 20° C. and less than or equal to 22° C.).

According to some embodiments, the method comprises separating CO₂ from the fluid source and/or removing CO₂ from the electrochemical system. Referring to FIGS. 1C-1D, for example, the method comprises separating CO₂ 122a from fluid source 108 and removing CO₂ 122a from electrochemical system 100a.

In some embodiments, the separating comprises separating CO₂ using a sweep gas. In some embodiments, for example, the separating comprises flowing a sweep gas through an inlet fluidically connected to an electrochemical cell, through a gaseous atmosphere of the electrochemical system, and through an outlet fluidically connected to the electrochemical cell. Referring to FIG. 2A, for example, the separating comprises flowing sweep gas 136 through inlet 132a, through gaseous atmosphere 128 of electrochemical system 100b, and through outlet 134.

Separating CO₂ from the fluid source may occur at any of a variety of temperatures. In certain embodiments, for example, the separating occurs at a temperature greater than or equal to 0° C., greater than or equal to 10° C., greater than or equal to 15° C., greater than or equal to 20° C., greater than or equal to 25° C., greater than or equal to 30° C., greater than or equal to 35° C., greater than or equal to 40° C., greater than or equal to 45° C., greater than or equal to 50° C., greater than or equal to 55° C., greater than or equal to 60° C., greater than or equal to 65° C., greater than or equal to 70° C., greater than or equal to 75° C., greater than or equal to 80° C., greater than or equal to 85° C., greater than or equal to 90° C., or greater than or equal to 95° C. In some embodiments, the separating occurs at a temperature less than or equal to 100° C., less than or equal to 95° C., less than or equal to 90° C., less than or equal to 85° C., less than or equal to 80° C., less than or equal to 75° C., less than or equal to 70° C., less than or equal to 65° C., less than or equal to 60° C., less than or equal to 55° C., less than or equal to 50° C., less than or equal to 45° C., less than or equal to 40° C., less than or equal to 35° C., less than or equal to 30° C., less than or equal to 25° C., less than or equal to 20° C., less than or equal to 15° C., less than or equal to 10° C., or less than or equal to 5° C. Combinations of the above recited ranges are possible (e.g., the separating occurs at a temperature greater than or equal to 0° C. and less than or equal to 100° C., the separating occurs at a temperature greater than or equal to 20° C. and less than or equal to 25° C.). Other ranges are also possible.

In certain embodiments, the separating occurs at room temperature (e.g., greater than or equal to 20° C. and less than or equal to 25° C., greater than or equal to 20° C. and less than or equal to 22° C.).

According to some embodiments, the method comprises charging the electrochemical cell. Referring to FIG. 1E, for example, the method comprises charging electrochemical cell 102 (represented by flow of electrons 120b).

In some embodiments, the charging comprises de-intercalating the first Lewis acid cation from the first electrode (e.g., the positive electrode). Referring, for example, to FIG. 1E, charging comprises de-intercalating first Lewis acid cation 112 from first electrode 104.

According to certain embodiments, the charging comprises plating the second Lewis acid cation onto the second electrode (e.g., the negative electrode). Referring to FIG. 1E, for example, charging comprises plating second Lewis acid cation 116 onto second electrode 106.

In some embodiments, as a result of the charging, the second Lewis acid cation de-interacts (e.g., disassociates) with the carbamate compound-second Lewis acid cation adduct. Referring to FIG. 1F, for example, second Lewis cation 116 de-interacts (e.g., disassociates) with adduct 124 and plates onto second electrode 116 (as shown, for example, in FIG. 1E) as a result of the charging.

Charging the electrochemical cell may occur at any of a variety of temperatures. In certain embodiments, for example, the charging occurs at a temperature greater than or equal to 0° C., greater than or equal to 10° C., greater than or equal to 15° C., greater than or equal to 20° C., greater than or equal to 25° C., greater than or equal to 30° C., greater than or equal to 35° C., greater than or equal to 40° C., greater than or equal to 45° C., greater than or equal to 50° C., greater than or equal to 55° C., greater than or equal to 60° C., greater than or equal to 65° C., greater than or equal to 70° C., greater than or equal to 75° C., greater than or equal to 80° C., greater than or equal to 85° C., greater than or equal to 90° C., or greater than or equal to 95° C. In some embodiments, the charging occurs at a temperature less than or equal to 100° C., less than or equal to 95° C., less than or equal to 90° C., less than or equal to 85° C., less than or equal to 80° C., less than or equal to 75° C., less than or equal to 70° C., less than or equal to 65° C., less than or equal to 60° C., less than or equal to 55° C., less than or equal to 50° C., less than or equal to 45° C., less than or equal to 40° C., less than or equal to 35° C., less than or equal to 30° C., less than or equal to 25° C., less than or equal to 20° C., less than or equal to 15° C., less than or equal to 10° C., or less than or equal to 5° C. Combinations of the above recited ranges are possible (e.g., the charging occurs at a temperature greater than or equal to 0° C. and less than or equal to 100° C., the charging occurs at a temperature greater than or equal to 20° C. and less than or equal to 25° C.). Other ranges are also possible.

In certain embodiments, the charging occurs at room temperature (e.g., greater than or equal to 20° C. and less than or equal to 25° C., greater than or equal to 20° C. and less than or equal to 22° C.).

According to some embodiments, the method comprises purging the fluid source with CO₂. Referring, for example, to FIG. 1H, the method comprises purging fluid source 108 with CO₂ 122b.

In certain embodiments, the purging comprises flowing CO₂ through an inlet fluidically connected to the electrochemical cell. Referring to FIG. 2B, for example, the purging comprises flowing CO₂ 122b through inlet 132b fluidically connected to electrochemical cell 102 such that CO₂ 122b is purged directly into fluid source 108.

In some embodiments, as a result of the purging, the carbamic acid compound is regenerated. Referring to FIG. 1H, for example, carbamic acid compound 118 is regenerated as a result of the purging.

Advantageously, by purging the fluid source with CO₂ and regenerating the carbamic acid compound, the electrochemical system is brought back to its initial state prior to discharging. In some embodiments, the electrochemical system is capable of being cycled (e.g., discharged and charged) any of a variety of suitable times. In some embodiments, for example, the electrochemical system is capable of being cycled greater than or equal to 2 times, greater than or equal to 5 times, greater than or equal to 10 times, greater than or equal to 20 times, greater than or equal to 30 times, greater than or equal to 40 times, greater than or equal to 50 times, greater than or equal to 60 times, greater than or equal to 70 times, greater than or equal to 80 times, greater than or equal to 90 times, greater than or equal to 100 times, greater than or equal to 150 times, greater than or equal to 200 times, greater than or equal to 250 times, greater than or equal to 300 times, greater than or equal to 350 times, greater than or equal to 400 times, or greater than or equal to 450 times. In certain embodiments, the electrochemical system is capable of being cycled less than or equal to 500 times, less than or equal to 450 times, less than or equal to 400 times, less than or equal to 350 times, less than or equal to 300 times, less than or equal to 250 times, less than or equal to 200 times, less than or equal to 150 times, less than or equal to 100 times, less than or equal to 90 times, less than or equal to 80 times, less than or equal to 70 times, less than or equal to 60 times, less than or equal to 50 times, less than or equal to 40 times, less than or equal to 30 times, less than or equal to 20 times, less than or equal to 10 times, or less than or equal to 5 times. Combinations of the above recited ranges are also possible (e.g., the electrochemical cell is capable of being cycled greater than or equal to 2 times and less than or equal to 500 times, the electrochemical cell is capable of being cycled greater than or equal to 40 times and less than or equal to 60 times). Other ranges are also possible.

The electrochemical system shown and described with respect to FIGS. 1A-1H comprises: (i) a first electrode (e.g., a positive electrode) comprising a material that is configured to intercalate a first Lewis acid cation (e.g., a K⁺, Na⁺, Li⁺, and/or Cs⁺ Lewis acid cation) upon discharge and to de-intercalate the first Lewis acid cation upon charge; and (ii) a second electrode (e.g., a negative electrode) comprising a metal that is configured to produce a second Lewis acid cation (e.g., a Zn²⁺, Mg²⁺, and/or Ca²⁺ Lewis acid cation) upon discharge and to plate the second Lewis acid cation onto the second electrode upon charge.

In some embodiments, the electrochemical system may comprise: (i) a first electrode (e.g., a positive electrode) comprising a material that is configured to de-intercalate the second Lewis acid cation (e.g., a Zn²⁺, Mg²⁺, Ca²⁺ Lewis acid cation) upon charge and to intercalate the second Lewis acid cation upon discharge; and (ii) a second electrode (e.g., a negative electrode) comprising a material that is configured to plate (or intercalate) the first Lewis acid cation onto (or into) the second electrode upon charge and to produce (or de-intercalate) the first Lewis acid cation (e.g., a K⁺, Na⁺, Li⁺, and/or Cs⁺ Lewis acid cation) upon discharge.

Any of a variety of suitable materials may be utilized for the first electrode that is configured to de-intercalate the second Lewis acid cation upon charge and to intercalate the second Lewis acid cation upon discharge. In certain embodiments, for example, the first electrode comprises a material that is capable of intercalating one or more Zn²⁺, Mg²⁺, and/or Ca²⁺ cations. In some embodiments, the first electrode comprises ZnLiV₃O₈, ZnNiₓMnₓCo₂₋₂ₓO₄, ZnAlₓMnₓCo₂₋₂ₓO₄, V₂O₅, Ca_{0.28}V₂O₅·H₂O, FeV₃O₉·1.2H₂O, Ag_{0.33}V₂O₅, NaV₃O₈, Mg_{0.3}V₂O₅·1.1H₂O, and/or α-MoO₃. Other materials are also possible.

Any of a variety of suitable materials may be utilized for the second electrode that is configured to plate (or intercalate) the first Lewis acid cation upon charge and to produce (or de-intercalate) the first Lewis acid cation upon discharge. In certain embodiments, for example, the second electrode comprises a material that is capable of intercalating one or more of K⁺, Na⁺, Li⁺, and/or Cs⁺ cations. In some embodiments, the second electrode comprises lithium titanate (e.g., Li₄Ti₅O₁₂) and/or titanium dioxide (TiO₂). Other materials are also possible.

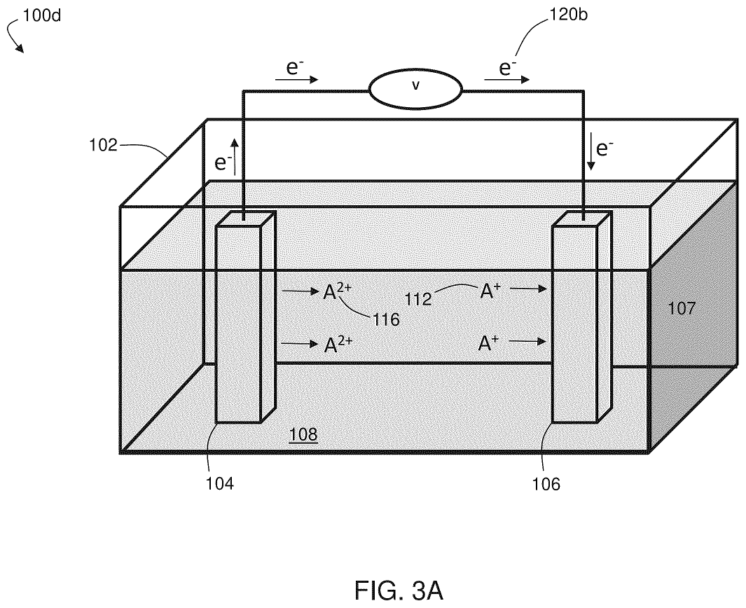

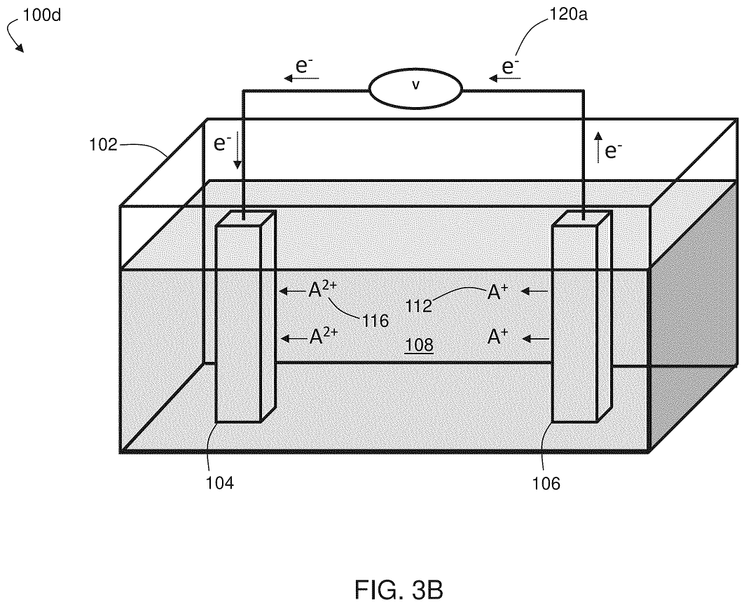

FIG. 3A shows, according to certain embodiments, electrochemical system 100d comprising first electrode 104 configured to de-intercalate second Lewis acid cation 116 and second electrode 106 configured to plate (or intercalate) first Lewis acid cation 112 upon charge. In certain embodiments, upon charge of electrochemical cell 102 (represented by flow 120b of electrons), first electrode 104 is configured to de-intercalate second Lewis acid cation 116 from first electrode 104 such that second Lewis acid cation interacts with a carbamic acid compound (e.g., a compound of the formula (R¹)₂NCOOH, wherein each R¹ is the same or different and is selected from the group consisting of hydrogen, deuterium, —C₁-C₁₀ alkyl, —C₂-C₁₀ alkenyl, —C₃-C₁₀ alkynyl, —C₃-C₁₀ cycloalkyl, and —R²—O—R², and each R² is the same or different and is selected from the group consisting of hydrogen, deuterium, —C₁-C₁₀ alkyl, —C₂-C₁₀ alkenyl, —C₃-C₁₀ alkynyl, and —C₃-C₁₀ cycloalkyl) in fluid source 108 to release CO₂ from the carbamic acid compound, thereby forming a carbamate compound-second Lewis acid cation adduct and an ammonium compound (as described in further detail herein with respect to FIG. 1C).

In some embodiments, upon charge of electrochemical cell 102 (represented by flow 120b of electrons), second electrode 106 is configured to plate (or intercalate) first Lewis acid cation 112 onto (or onto) second electrode 106.

FIG. 3B shows, according to certain embodiments, electrochemical system 100d comprising a first electrode configured to intercalate a second Lewis acid cation and a second electrode configured to produce (or de-intercalate) a first Lewis acid cation upon discharge. In some embodiments, upon discharge of electrochemical cell 102 (represented by flow 120a of electrons), first electrode 104 is configured to intercalate second Lewis acid cation 116 such that second Lewis acid cation de-interacts (e.g., disassociates) from the carbamate compound-second Lewis acid cation adduct and intercalates into first electrode 104 (as described in further detail herein with respect to FIG. 1H).

In certain embodiments, upon discharge of electrochemical cell 102 (represented by flow 120a of electrons), second electrode 106 is configured to produce (or de-intercalate) first Lewis acid cation 112.

According to some embodiments, a method of separating CO₂ from a fluid source comprises providing an electrochemical cell in the fluid source, wherein the electrochemical cell comprises a first electrode (e.g., a positive electrode, such as an electrode comprising ZnLiV₃O₈, ZnNiₓMnₓCo₂₋₂ₓO₄, ZnAlₓMnₓCo₂₋₂ₓO₄, V₂O₅, Ca_{0.28}V₂O₅·H₂O, FeV₃O₉·1.2H₂O, Ag_{0.33}V₂O₅, NaV₃O₈, Mg_{0.3}V₂O₅·1.1H₂O, and/or α-MoO₃) and a second electrode (e.g., a negative electrode, such as an electrode comprising Li₄Ti₅O₁₂ or TiO₂), the fluid source comprises an electrolyte salt and a carbamic acid compound, and the electrolyte salt comprises a first Lewis acid cation, as described herein.

In certain embodiments, the providing occurs at any of a variety of suitable temperatures (e.g., greater than or equal to 0° C. and less than or equal to 100° C.). In some embodiments, the providing occurs at room temperature (e.g., greater than or equal to 20° C. and less than or equal to 25° C., greater than or equal to 20° C. and less than or equal to 22° C.).

In certain embodiments, the method comprises charging the electrochemical cell. Referring, for example, to FIG. 3A, the method comprises charging electrochemical cell 102 (represented by flow of electrons 120b).

In some embodiments, the charging comprises producing a second Lewis acid cation from the first electrode (e.g., the positive electrode) such that the second Lewis acid cation interacts with the carbamic acid compound and releases CO₂ from the carbamic acid compound. Referring, for example, to FIG. 3A, the charging comprises producing second Lewis acid cation 116 from first electrode 104 such that the second Lewis acid cation interacts with the carbamic acid compound and releases CO₂ from the carbamic acid compound, thereby generating an ammonium compound and a carbamate compound-second Lewis acid cation adduct (e.g., as explained herein in greater detail with respect to FIG. 1C).

According to some embodiments, the charging comprises plating the first Lewis acid cation onto the second electrode (e.g., the negative electrode) or intercalating the first Lewis acid cation into the negative electrode (e.g., the negative electrode). For example, referring to FIG. 3A, the charging comprises plating first Lewis acid cation 112 onto second electrode 106 or intercalating first Lewis acid cation 112 into second electrode 106.

In certain embodiments, the discharging occurs at any of a variety of suitable temperatures (e.g., greater than or equal to 0° C. and less than or equal to 100° C.). In some embodiments, the discharging occurs at room temperature (e.g., greater than or equal to 20° C. and less than or equal to 25° C., greater than or equal to 20° C. and less than or equal to 22° C.).

According to some embodiments, the method comprises separating CO₂ from the fluid source and removing CO₂ from the electrochemical system (e.g., as explained herein in greater detail with respect to FIGS. 1C-1D). In certain embodiments, the separating comprises separating CO₂ using a sweep gas (e.g., as explained herein in greater detail with respect to FIG. 2A).

In certain embodiments, the separating occurs at any of a variety of suitable temperatures (e.g., greater than or equal to 0° C. and less than or equal to 100° C.). In some embodiments, the separating occurs at room temperature (e.g., greater than or equal to 20° C. and less than or equal to 25° C., greater than or equal to 20° C. and less than or equal to 22° C.).

According to some embodiments, the method comprises discharging the electrochemical cell. Referring, for example, to FIG. 3B, the method comprises discharging electrochemical cell 102 (represented by flow of electrons 120a).

In some embodiments, the discharging comprises intercalating the second Lewis acid cation into the first electrode (e.g., the positive electrode). Referring to FIG. 3B, for example, the discharging comprises intercalating second Lewis acid cation 116 into first electrode 104.

In certain embodiments, as a result of the discharging, the second Lewis acid cation de-interacts (e.g., disassociates) with the carbamate compound-second Lewis acid cation adduct, as explained herein in greater detail with respect to FIG. 1F.

According to some embodiments, the discharging comprises producing the first Lewis acid cation from the second electrode (e.g., the negative electrode) or de-intercalating the first Lewis acid cation from the second electrode (e.g., the negative electrode). For example, referring to FIG. 3B, the discharging comprises producing first Lewis acid cation 112 from second electrode 106 or de-intercalating first Lewis acid cation 112 from second electrode 106.

In certain embodiments, the discharging occurs at any of a variety of suitable temperatures (e.g., greater than or equal to 0° C. and less than or equal to 100° C.). In some embodiments, the discharging occurs at room temperature (e.g., greater than or equal to 20° C. and less than or equal to 25° C., greater than or equal to 20° C. and less than or equal to 22° C.).

According to certain embodiments, the method comprises purging the fluid source with CO₂, thereby regenerating the carbamic acid compound (e.g., as explained herein in greater detail with respect to FIG. 1H). In some embodiments, the purging comprises flowing CO₂ through an inlet fluidically connected to the electrochemical cell (e.g., as explained herein in greater detail with respect to FIG. 2B).

Advantageously, by purging the fluid source with CO₂ and regenerating the carbamic acid compound, the electrochemical system is brought back to its initial state prior to charging. In some embodiments, the electrochemical system is capable of being cycled (e.g., charged and discharged) any of a variety of suitable times. In some embodiments, for example, the electrochemical system is capable of being cycled greater than or equal to 2 times, greater than or equal to 5 times, greater than or equal to 10 times, greater than or equal to 20 times, greater than or equal to 30 times, greater than or equal to 40 times, greater than or equal to 50 times, greater than or equal to 60 times, greater than or equal to 70 times, greater than or equal to 80 times, greater than or equal to 90 times, greater than or equal to 100 times, greater than or equal to 150 times, greater than or equal to 200 times, greater than or equal to 250 times, greater than or equal to 300 times, greater than or equal to 350 times, greater than or equal to 400 times, or greater than or equal to 450 times. In certain embodiments, the electrochemical system is capable of being cycled less than or equal to 500 times, less than or equal to 450 times, less than or equal to 400 times, less than or equal to 350 times, less than or equal to 300 times, less than or equal to 250 times, less than or equal to 200 times, less than or equal to 150 times, less than or equal to 100 times, less than or equal to 90 times, less than or equal to 80 times, less than or equal to 70 times, less than or equal to 60 times, less than or equal to 50 times, less than or equal to 40 times, less than or equal to 30 times, less than or equal to 20 times, less than or equal to 10 times, or less than or equal to 5 times. Combinations of the above recited ranges are also possible (e.g., the electrochemical cell is capable of being cycled greater than or equal to 2 times and less than or equal to 500 times, the electrochemical cell is capable of being cycled greater than or equal to 40 times and less than or equal to 60 times). Other ranges are also possible.

The energy consumption (e.g., CO₂ separation energy) of the electrochemical systems described herein may be any of a variety of suitable values. According to certain embodiments, the energy consumption of the electrochemical system may be advantageously low. In some embodiments, for example, the energy consumption of the electrochemical system is less than or equal to 100 kJ/mol CO₂, less than or equal to 95 kJ/mol CO₂, less than or equal to 90 kJ/mol CO₂, less than or equal to 85 kJ/mol CO₂, less than or equal to 80 kJ/mol CO₂, less than or equal to 75 kJ/mol CO₂, less than or equal to 70 kJ/mol CO₂, less than or equal to 65 kJ/mol CO₂, less than or equal to 60 kJ/mol CO₂, less than or equal to 55 kJ/mol CO₂, less than or equal to 50 kJ/mol CO₂, less than or equal to 45 kJ/mol CO₂, less than or equal to 40 kJ/mol CO₂, less than or equal to 35 kJ/mol CO₂, less than or equal to 30 kJ/mol CO₂, less than or equal to 25 kJ/mol CO₂, less than or equal to 20 kJ/mol CO₂, or less than or equal to 15 kJ/mol CO₂ at 0.1 mA/cm². In certain embodiments, the energy consumption of the electrochemical system is greater than or equal to 10 kJ/mol CO₂, greater than or equal to 15 kJ/mol CO₂, greater than or equal to 20 kJ/mol CO₂, greater than or equal to 25 kJ/mol CO₂, greater than or equal to 30 kJ/mol CO₂, greater than or equal to 35 kJ/mol CO₂, greater than or equal to 40 kJ/mol CO₂, greater than or equal to 45 kJ/mol CO₂, greater than or equal to 50 kJ/mol CO₂, greater than or equal to 55 kJ/mol CO₂, greater than or equal to 60 kJ/mol CO₂, greater than or equal to 65 kJ/mol CO₂, greater than or equal to 70 kJ/mol CO₂, greater than or equal to 75 kJ/mol CO₂, greater than or equal to 80 kJ/mol CO₂, greater than or equal to 85 kJ/mol CO₂, greater than or equal to 90 kJ/mol CO₂, or greater than or equal to 95 kJ/mol CO₂ at 0.1 mA/cm². Combinations of the above recited ranges are possible (e.g., the energy consumption of the electrochemical system is less than or equal to 100 kJ/mol CO₂ and greater than or equal to 10 kJ/mol CO₂ at 0.1 mA/cm², the energy consumption of the electrochemical system is less than or equal to 25 kJ/mol CO₂ and greater than or equal to 20 kJ/mol CO₂ at 0.1 mA/cm²). Other ranges are also possible.

In some embodiments, the energy consumption of the electrochemical system may be calculated based on the charge and discharge curves of the electrochemical cell and the total amount of CO₂ released, wherein the energy consumption for one cycle of the electrochemical system is the difference in energy between the energy consumed during charging and the energy released during discharging the electrochemical cell.

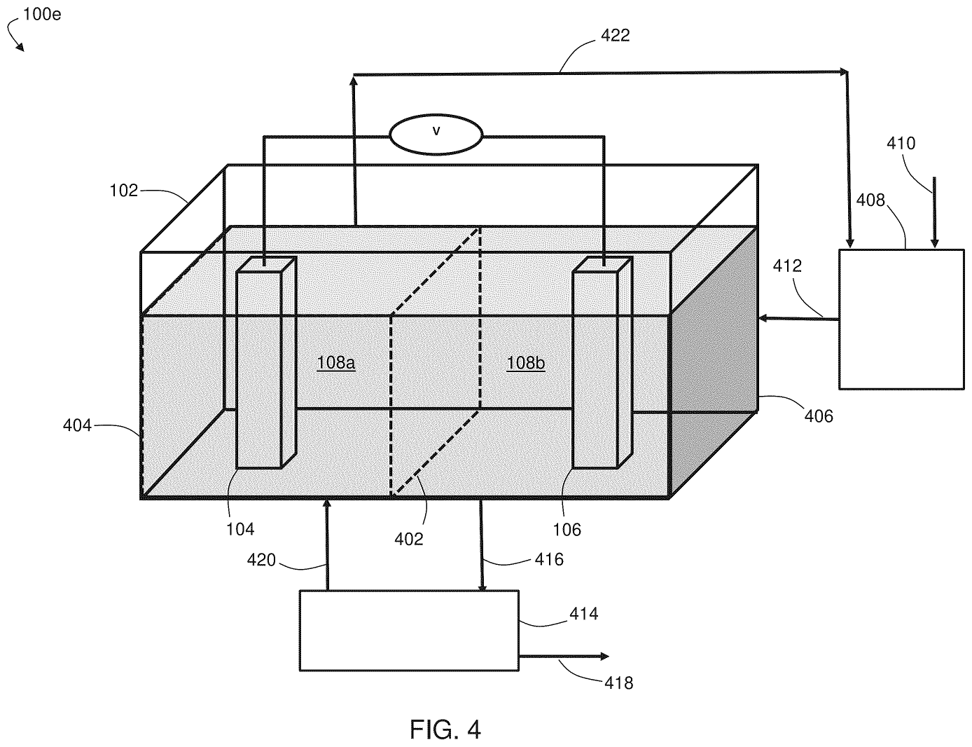

The electrochemical system described herein may be configured as a flow cell, in accordance with certain embodiments. In certain embodiments, for example, the flow cell may advantageously be continuously operated to remove CO₂ from a fluid source. FIG. 4 shows, according to certain embodiments, a schematic diagram of electrochemical system 100e configured as a flow cell. The electrochemical system configured as a flow cell may comprise a first electrode (e.g., a positive electrode), a second electrode (e.g., a negative electrode), an exchange membrane (e.g., an anion exchange membrane), and a fluid source. As shown in FIG. 4, for example, electrochemical system 100e comprises first electrode 104, second electrode 106, exchange membrane 402 located between first electrode 104 and second electrode 106, and fluid source 108 (e.g., fluid source 108a and fluid source 108b).

In some embodiments, the first electrode (e.g., the positive electrode) and the second electrode (e.g., the negative electrode) comprise a metal. Referring to FIG. 4, for example, first electrode 104 and second electrode 106 comprise a metal. Suitable metals include, but are not limited to, zinc (Zn), magnesium (Mg), calcium (Ca), and/or combinations thereof.

According to some embodiments, the exchange membrane (e.g., the anion exchange membrane) located between the first electrode (e.g., the positive electrode) and the second electrode (e.g., the negative electrode) may form a cathode chamber and an anode chamber. Referring to FIG. 4, for example, exchange membrane 402 located between first electrode 104 and second electrode 106 forms cathode chamber 404 (e.g., comprising first electrode 104 and fluid source 108a) and anode chamber 406 (e.g., comprising second electrode 106 and fluid source 108b). The fluid source in the cathode chamber (e.g., fluid source 108a) may be a catholyte comprising an electrolyte salt, in accordance with certain embodiments. In some embodiments, the fluid source in the anode chamber (e.g., fluid source 108b) may be an anolyte comprising the electrolyte salt. The electrolyte salt may, in some embodiments, comprise a K-containing salt, a Na-containing salt, a Li-containing salt, a Cs-containing salt, a Zn-containing salt, a Mg-containing salt, a Ca-containing salt, and/or combinations thereof.

According to some embodiments, the electrochemical system configured as a flow cell comprises a CO₂ absorber. Referring to FIG. 4, for example, electrochemical system 100e comprises CO₂ absorber 408. In certain embodiments, the CO₂ absorber comprises fluid source 108 (e.g., 108a) comprising the electrolyte salt and a carbamate compound (e.g., a compound of the formula (R¹)₂NCOO⁻, wherein each R¹ is the same or different and is selected from the group consisting of hydrogen, deuterium, —C₁-C₁₀ alkyl, —C₂-C₁₀ alkenyl, —C₃-C₁₀ alkynyl, —C₃-C₁₀ cycloalkyl, and —R²—O—R², and each R² is the same or different and is selected from the group consisting of hydrogen, deuterium, —C₁-C₁₀ alkyl, —C₂-C₁₀ alkenyl, —C₃-C₁₀ alkynyl, and —C₃-C₁₀ cycloalkyl).

The CO₂ absorber may comprise one or more inlets for introducing CO₂ into the CO₂ absorber. As shown in FIG. 4, for example, CO₂ absorber 408 comprises inlet 410 for introducing CO₂ into CO₂ absorber 408. In certain embodiments, the CO₂ introduced into the CO₂ absorber may generate a carbamic acid compound (e.g., a compound of the formula (R¹)₂NCOOH, wherein each R¹ is the same or different and is selected from the group consisting of hydrogen, deuterium, —C₁-C₁₀ alkyl, —C₂-C₁₀ alkenyl, —C₃-C₁₀ alkynyl, —C₃-C₁₀ cycloalkyl, and —R²—O—R², and each R² is the same or different and is selected from the group consisting of hydrogen, deuterium, —C₁-C₁₀ alkyl, —C₂-C₁₀ alkenyl, —C₃-C₁₀ alkynyl, and —C₃-C₁₀ cycloalkyl).

In some embodiments, the CO₂ absorber may comprise one or more outlets fluidically connected to the anodic chamber. Referring to FIG. 4, for example, CO₂ absorber 408 comprises outlet 412 fluidically connected to anodic chamber 406. The outlet may be configured to flow the fluid source 108 (e.g., 108b) comprising the electrolyte salt and the carbamic acid compound to the anodic chamber, in accordance with certain embodiments.

In some embodiments, upon discharge of the electrochemical cell, the second electrode is configured to produce a Lewis acid cation of the electrolyte salt. In certain embodiments, for example, the metal of the second electrode may be oxidized to a cationic oxidation state, thereby producing the Lewis cation of the electrolyte salt. In certain embodiments, the Lewis cation produced upon discharge of the electrochemical cell comprises a Zn²⁺, a Mg²⁺, and/or a Ca²⁺ Lewis acid cation.

In certain embodiments, as the fluid source comprising the electrolyte salt and the carbamic acid compound is flowed from the CO₂ absorber to the anodic chamber, the Lewis acid cation produced by the second electrode during discharge interacts with the carbamic acid compound to release CO₂ from the carbamic acid compound, thereby generating CO₂, an ammonium compound, and a carbamate compound-Lewis acid cation adduct (e.g., as explained herein in greater detail with respect to FIG. 1C).

According to some embodiments, the electrochemical system configured as a flow cell comprises a CO₂ desorber. Referring to FIG. 4, for example, electrochemical system 100e comprises CO₂ desorber 414. The CO₂ desorber may comprise one or more inlets fluidically connected to the anodic chamber for introducing the fluid source comprising the electrolyte salt, CO₂ released from the carbamic acid compound, and the carbamate compound into the CO₂ desorber from the anodic chamber. As shown in FIG. 4, for example, CO₂ desorber 414 comprises inlet 416 fluidically connected to anodic chamber 406 for introducing fluid source 108 (e.g., 108b) comprising the electrolyte salt, the CO₂ released from the carbamic acid compound, and the carbamate compound into CO₂ desorber 414 from anodic chamber 406.

In certain embodiments, the CO₂ desorber may comprise one or more outlets for releasing CO₂ from the CO₂ desorber. Referring, for example, to FIG. 4, CO₂ desorber 414 comprises outlet 418 for releasing CO₂ from CO₂ desorber 414.

According to some embodiments, the CO₂ desorber may comprise one or more outlets fluidically connected to the cathodic chamber for introducing the fluid source comprising the electrolyte salt and the carbamate compound into the cathodic chamber. Referring, for example, to FIG. 4, CO₂ desorber comprises outlet 420 fluidically connected to cathodic chamber 404 for introducing fluid source 108 (e.g., 108a) comprising the electrolyte salt and the carbamate compound into cathodic chamber 404.

According to certain embodiments, upon discharge of the electrochemical cell, the first electrode is configured to plate the Lewis acid cation of the electrolyte salt onto the first electrode. In some embodiments, for example, the Lewis acid cation of the electrolyte salt (e.g., a Zn²⁺, a Mg²⁺, and/or a Ca²⁺ Lewis acid cation) may be reduced to a metal (e.g., a neutral metal) and plated onto the first electrode.

According to certain embodiments, the cathodic chamber may comprise one or more outlets fluidically connected to the CO₂ absorber for introducing the fluid source comprising the electrolyte salt and the carbamate compound into the CO₂ absorber from the cathodic chamber. Referring to FIG. 4, for example, cathodic chamber 404 comprises outlet 422 for introducing fluid source 108 (e.g., 108a) comprising the electrolyte salt and the carbamate compound into CO₂ absorber 408 from cathodic chamber 404.

### Example 1

The following examples describes a dual salt cation-swing process for electrochemical CO₂ separation.

Mitigating anthropogenic CO₂ emissions from fossil fuel combustion requires development of improved CO₂ separation technologies with low energy requirements, durability, and versatility. While renewables-based electrification of key industries like power generation must be prioritized, starkly fewer solutions are immediately available for hard-to-decarbonize sectors such as heat- and CO₂-intensive manufacturing (e.g., cement, steel, and chemical production). The conventional CO₂ separation process utilizes aqueous amine solutions that operate via a temperature swing between −40° C. on capture and 120-130° C. upon regeneration. This conventional process faces long-standing challenges such as high energy requirements (>80 kJ/mol CO₂) for amine regeneration, amine degradation at high temperature, corrosion, aerosol production, and high capital and operating costs, among others, therefore limiting practical deployment. In this context, electrochemical separation approaches are attractive due to several advantages, including ambient operating conditions, amenability towards direct integration with renewables as the energy input, and potential for modular designs. Examples of electrochemical CO₂ separation processes include electrochemically mediated amine regeneration (EMAR), direct redox of organic sorbent molecules (e.g., quinones, bipyridine, neutral red, etc.), and pH swing methods achieved through water electrolysis or use of bipolar membranes. Demonstrated energy requirements for these electrochemical processes at the cell level range from 30 to 100 kJ mol⁻¹ CO₂, evidencing their potential competitiveness with thermal-swing approaches if scaling can be achieved.

While most conventional CO₂ capture processes including those with amines employ aqueous solutions, there has been growing consideration of conducting both conventional and electrochemical separation in non-aqueous media. One advantage of doing so is the higher amine-CO₂ loading that can be reached by exploiting the tendency of some nonaqueous solvents to stabilize chemisorbed CO₂ as neutrally charged carbamic acid (RNHCOOH, 1 mol CO₂/mol amine) compared to a maximum of ˜0.5 mol CO₂/mol amine (ionic ammonium carbamate, RNH₃⁺RNHCOO⁻) favored in primary/secondary amine aqueous solutions. The higher loading in nonaqueous solution has been attributed to hydrogen bonding stabilization between solvent and carbamic acid, whereas water does not effectively stabilize the acid form. For nonaqueous amine solutions that favor carbamic acid, sustaining an electrochemical process requires inclusion of a supporting electrolyte salt to impart ionic conductivity to the electrolyte, which can interact with amine species in solution and lead to speciation changes. For instance, it was observed by ¹H NMR spectroscopy that, while DMSO-based amine solutions favor carbamic acid, addition of a supporting Li⁺-based salt induced a substantial speciation change from −100% carbamic acid to a lower limit of ˜50% carbamate/˜50% ammonium (2RNHCOOH+LiClO₄→RNH₃⁺+RNHCOO⁻Li⁺+CO₂+ClO₄⁻). This speciation change implied release of one CO₂ from every two amine molecules to achieve the stoichiometric charge rebalancing triggered by the favorable interaction of Li⁺ with RNHCOO⁻, though direct evidence of CO₂ release triggered by cation change was not obtained. The re-speciation reaction in the presence of varied alkali cations was also investigated, and it was concluded that the cation Lewis acidity sensitively affected the rate and extent of the above reaction. For instance, weaker K⁺ cations underwent negligible interaction with carbamic acid and formed negligible amounts of carbamate compared to the stronger Lewis acid Li⁺ cations.

Such a process was exploited in an electrochemical configuration designed to actively trigger changes in metal cation population in an electrolyte and drive cyclical changes in CO₂ loading under isothermal (room-temperature) conditions. In this example, an electrochemical cation-swing process that alternates between dominance of weak or strong Lewis acid cations in the electrolyte is described. By charging or discharging the cell, the thermodynamically favored amine species were reversibly toggled between carbamic acid or carbamate, allowing CO₂ to be released or absorbed from the cell, respectively. Factors influencing this conversion process were investigated in detail, including the selection of ionic species (e.g., Li⁺, K⁺, Ca²⁺, Mg²⁺, or Zn²⁺) and amine-to-ion concentration ratios, and these factors are supported by detailed solution ¹H NMR and additional product characterization to validate CO₂ loading changes in the different ion environments. Performance in a two-electrode electrochemical cell combining an ion-intercalating K⁺ cathode and Zn metal foil anode was also validated, which allowed for the ionic populations in solution to be cyclically and controllable modulated. These modulations were shown to couple directly with CO₂ capture and release in the cell, with agreement between theoretical and observed CO₂ loading changes. Finally, the energy requirements and longevity of such a cell over cycling was examined, showing stability over 30 cycles.

### Electrolyte Parameter Exploration

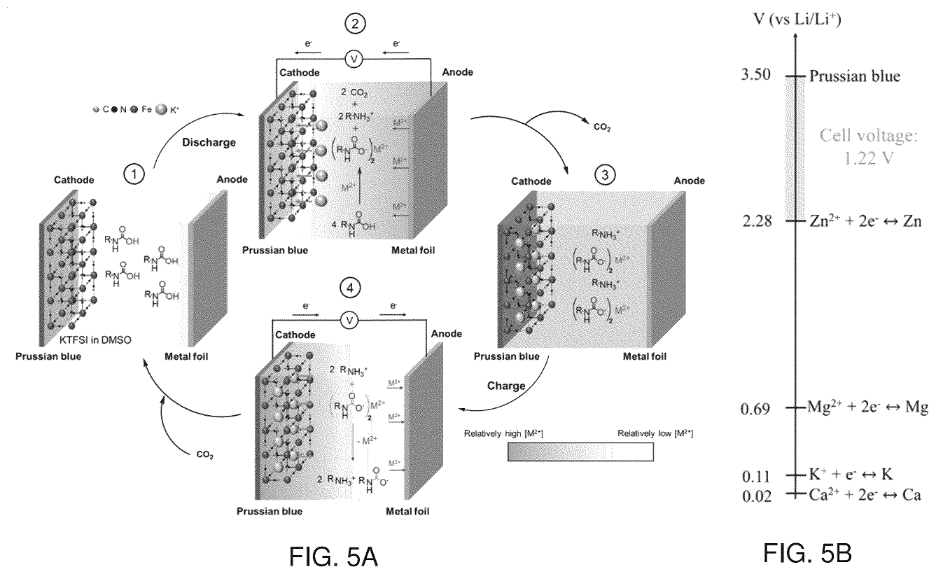

FIG. 5A shows the general cyclic scheme of the dual-ion cell during discharge and charge, and FIG. 5B shows the standard reduction potential of Prussian blue and various metal cations. K⁺ was used as the weak Lewis acid cation in the electrolyte given that it has minimal interaction with carbamic acid and maintains high amine CO₂ loading. In implementing this scheme, a representative K⁺ intercalation cathode with high redox potential (2.5-4.0 V vs. K/K⁺) was utilized instead of reactive K metal foil to avoid hydrogen evolution upon direct reaction with ammonium cations. A metal foil M, yielding a cation (M⁺ or M²⁺) upon oxidation with stronger Lewis acidity than K⁺, served as the counter electrode. In summary, discharging the dual-ion cell intercalates K⁺ into the K⁺ storage cathode and strips M²⁺ from the metal anode. M²⁺ then reacts with carbamic acid to form carbamate (RNHCOO⁻) and release CO₂. Subsequently, charging the cell de-intercalates K⁺ from the K⁺ storage cathode and plates M²⁺ back onto the metal anode, which favors re-formation of carbamic acid and enables additional CO₂ to be captured by the amine.

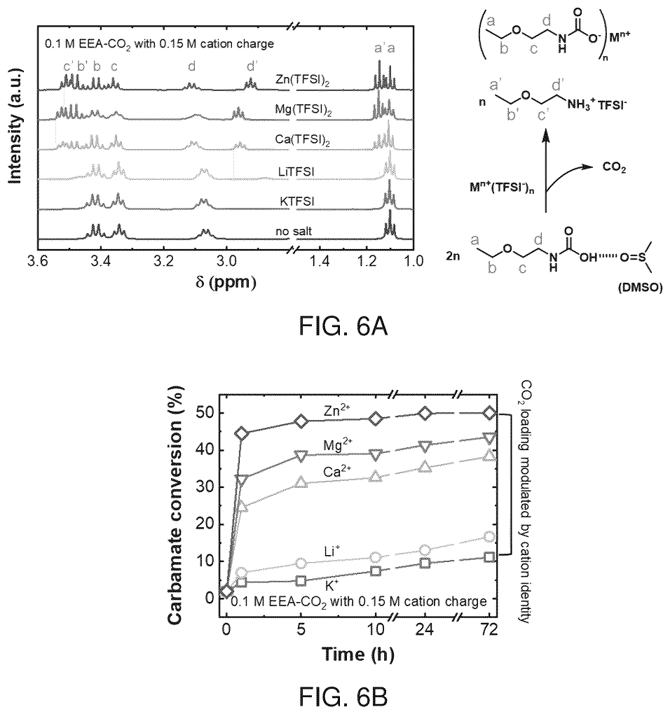

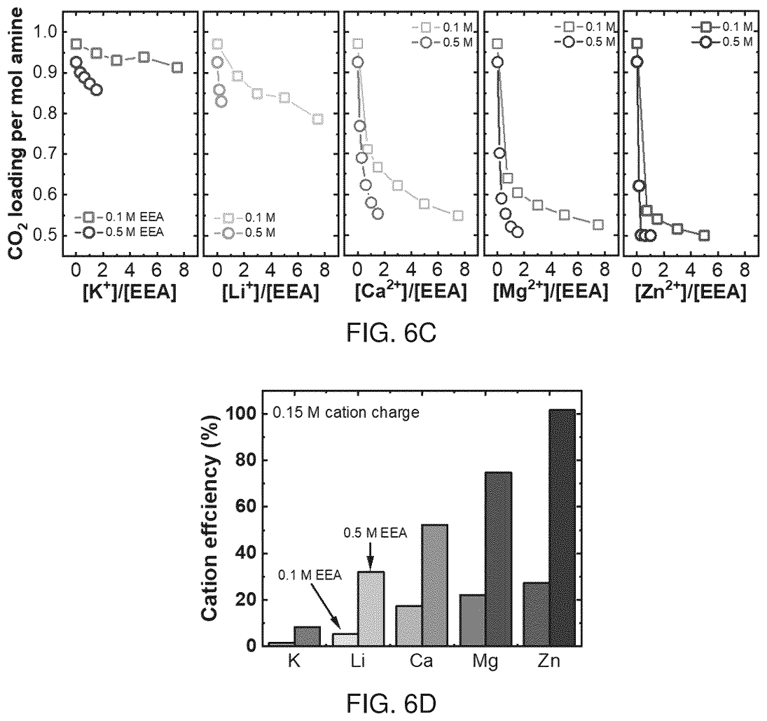

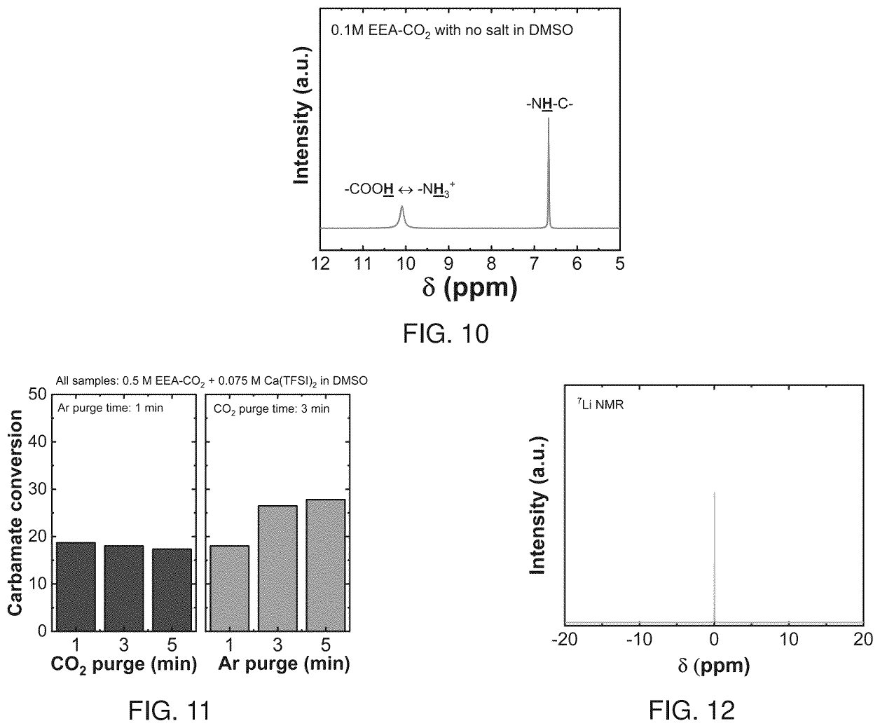

To identify a suitably strong Lewis acid co-cation to achieve a reasonable CO₂ loading swing, ¹H NMR was used to screen the influence of several candidate ions on the amine speciation. FIG. 6A shows the resulting spectra of 0.1 M EEA-CO₂ in DMSO-d₆ without salt, or with 0.15 M cation charge concentration of various co-salts: KTFSI, LiTFSI, Ca(TFSI)₂, Mg(TFSI)₂, or Zn(TFSI)₂ (i.e., 0.15 M for monovalent cations and 0.075 M for divalent cations), where salt was added after purging the solutions with CO₂. The TFSI⁻ anion was used in all cases to support high salt dissociation. For the spectra of 0.1 M EEA-CO₂ without salt, peaks at 1.1, 3.1, 3.3, and 3.4 ppm (labeled a, b, c, and d) are from carbamic acid. In contrast, when co-salt was added to solution, additional peaks emerged in all cases at around 1.2, 3.0, and 3.5 ppm (a′, b′, c′, and d′) attributed to the formation of ammonium cations. The formation of ammonium implies an equimolar amount of carbamate (FIG. 6A reaction scheme), which shares the same ¹H NMR peak with carbamic acid due to fast proton exchange and cannot be independently distinguished. Comparing the peak area ratios of ammonium to that of the carbamic acid for each co-salt enabled quantification of each species in the electrolyte (FIG. 10). These results are summarized in FIG. 6B, which shows the proportion of carbamate in the presence of each ionic species as a function of NMR sample acquisition time. Note that the detected equilibrium conversion amounts measured by NMR depend on several factors, including CO₂/Ar purge time and gas purge flow rate, which in turn establish the CO₂ partial pressure and solution concentrations of CO₂ (FIG. 11).

Consistent with prior results, addition of 0.15 M of K⁺ induced little speciation change, reaching only 5% carbamic acid conversion to carbamate after 5 hours and stabilizing at 11% after 72 hours (compared to a maximum possible change of 50%). Meanwhile, conversion in the presence of Li⁺ was higher, reaching 9.5% and 17% after 5 and 72 hours, respectively, due to the higher Lewis acidity of the monovalent cation compared to K⁺. The conversion extent and rates among divalent cations (Ca²⁺, Mg²⁺, and Zn²+, 0.075 M) also increased in a manner proportional to Lewis acidity (Ca²⁺<Mg²⁺<Zn²⁺) and were yet higher, yielding 25, 32, and 44% in 5 hours. Cation-dependent trends are further examined in FIG. 6C, which compares the speciation after 2 hours but now as a function of the injected salt concentration over a broader range (0.0 M-0.75 M). For all cations, CO₂ loadings decreased monotonically for 0.1 M EEA with increasing cation concentration. This trend was weakest for K⁺ which yielded only minor speciation change, even up to a large salt excess of 0.75 M ([K⁺]/[EEA]=7.5, 0.92 mol CO₂/mol amine). This further supports the assertion that K⁺, the weakest Lewis acid cation, can be added to carbamic acid solutions up to relatively high concentrations without significantly perturbing the carbamic acid population and CO₂ loading. Meanwhile, full conversion of 0.1 M EEA to carbamate could be achieved with 0.5 M Zn²⁺, albeit with large excess Zn²⁺ concentration than is minimally required to achieve charge balance (0.025 M), i.e., if all Zn²⁺ interacted directly with EEACOO⁻. In other words, dilute amounts of EEA require large excess cation concentrations to drive the conversion reaction to completion. This is reflected in the relatively low cation conversion efficiencies plotted in FIG. 6D, which represents the molar increase in carbamate after salt addition compared to the injected cation charge concentration in the electrolyte (cation

$$( cation conversion efficiency = \frac{Increased carbamate concentration [ M ]}{Injected cation charge concentration [ M ]} ) .$$

Cation conversion efficiency is a measure of the strength of a cation to convert carbamic acid to ammonium carbamate and release CO₂. This parameter ranges from 0 (no carbamic acid conversion) to 100%, indicating that every charge of the added cations participates in the conversion of carbamic acid to carbamate. Even in the best case of Zn²⁺, the cation conversion efficiency reached only ˜20% for 0.1 M EEA.

On the other hand, more extensive and rapid conversion was achieved in all cases by increasing the amine concentration to 0.5 M EEA-CO₂ (FIG. 6C). Even without salt, the CO₂ loading on amines, corresponding to carbamic acid, decreased slightly to 0.93 mol CO₂/mol amine for 0.5 M EEA compared to 0.97 mol CO₂/mol amine for 0.1 M. For K⁺-injected solutions, the CO₂ loading remained at ˜0.9 CO₂ per amine even up to 0.5 M of added salt ([K⁺]/[EEA]=1). In the case of LiTFSI solutions, increasing the total amine and salt concentrations led to noticeable precipitate formation, which upon extraction and analysis by ⁷Li NMR was found to be a Li-carbamate salt (FIG. 12). No such precipitation was observed in the other cases. As before, the highest conversion extents and rates were achieved with Zn²⁺, which closely approached 100% cation efficiency with 0.5 M EEA-CO₂. Overall, these findings imply that the CO₂ loading change between a 100% K⁺ or a 100% Zn²⁺ solution approaches ˜40%, closest to the theoretical maximum of 50% possible in any scenario.

### Confirmation and Driving Force for CO₂ Release

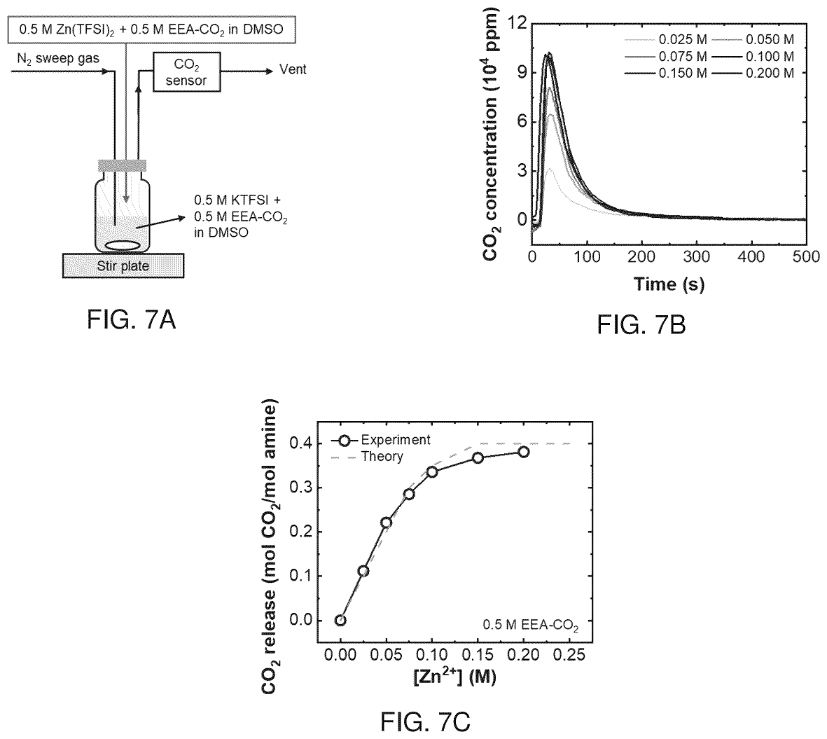

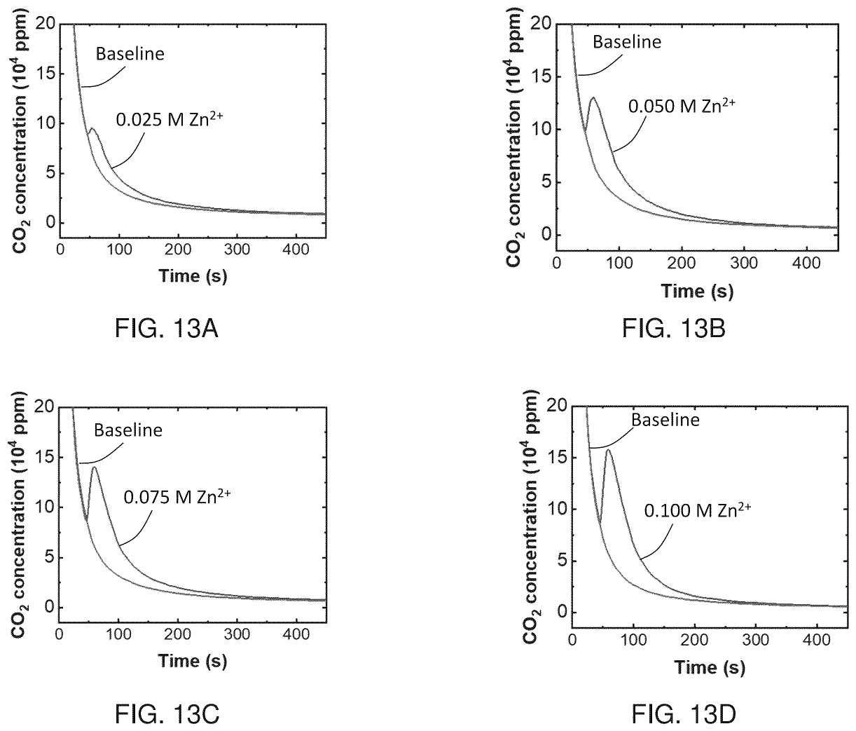

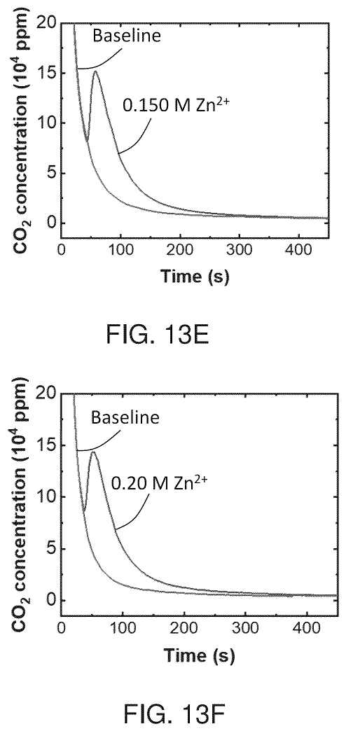

To directly confirm CO₂ release upon salt injection, an experimental setup was designed to simulate the cation-swing behavior with corresponding GC analysis (FIG. 7A). In this experiment, an electrolyte containing 0.5 M Zn(TFSI)₂/0.5 M EEA-CO₂ was injected into an electrolyte containing 0.5 M KTFSI/0.5 M EEA-CO₂. EEA-CO₂ was included in both solutions to retain a constant amine concentration, while the injection led to an increase of Zn²⁺ and decrease of K⁺ concentration (see Table 2). As the final injected Zn²⁺ concentration was varied from 0.025 M to 0.2 M (FIG. 7B, raw data in FIGS. 13A-13F), the measured CO₂ release increased monotonically and matched quantitatively with the expected amounts based on ¹H NMR speciation data (FIG. 7C, details in Tables 2 and 3). Beyond [Zn²+]=0.20 M, the released CO₂ plateaued, indicating that all of the carbamic acid was converted to ammonium carbamate at [Zn²⁺]˜0.15 M. Overall, this experiment provides an important proof to verify the carbamic acid-to-carbamate reaction mechanism.

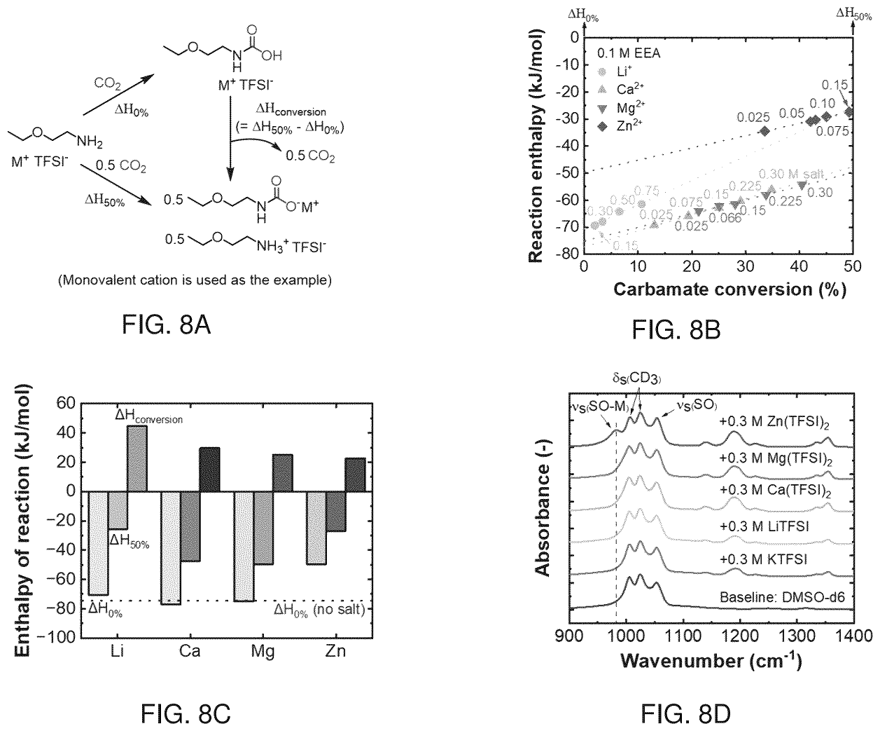

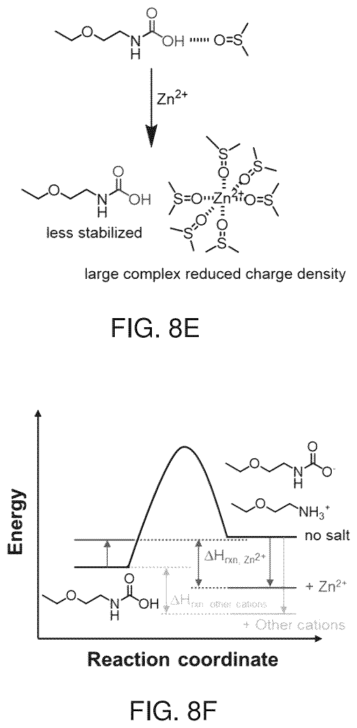

The thermodynamic driving force of the carbamic acid-to-carbamate conversion was also experimentally investigated. While EEA-CO₂ is highly stabilized as carbamic acid in pure DMSO, adding salt may destabilize carbamic acid (reactant) and/or stabilize the ammonium carbamate (product). To better understand which energy level shift dominated this speciation change, gas-flow reaction microcalorimetry was conducted to measure the enthalpy of reaction between EEA/CO₂ in the different electrolyte environments. In the experiments, lean amine (0.1 M) was reacted with CO₂ under isothermal conditions (T=25° C.) under a range of salt concentrations. For all solutions except pure EEA in DMSO, CO₂ purging creates a combination of carbamic acid and carbamate (FIG. 8A), with the measured enthalpy linearly proportional to the degree of conversion (FIG. 8B). The linearity of enthalpy with loading enabled extrapolation to theoretical limits of ΔH_{0%} (forming 100% carbamic acid in DMSO with salt) and ΔH_{50%} (forming 100% ammonium carbamate in DMSO with salt), both of which cannot be measured directly because such extrema states are never reached in practice with salt present. The difference between ΔH_{0%} and ΔH_{50%} allows for determination of ΔH_{conversion} (FIG. 8A) corresponding to the enthalpy of cation association with carbamic acid and subsequent conversion to carbamate+ammonium+CO₂.

In all cases, increasing the salt concentration led to less negative enthalpies of reaction. This occurs because fewer total N—C bonds form with higher salt concentration (carbamic acid: 1 N—C bond per amine; ammonium carbamate: 0.5 N—C bond per amine). Li⁺, Ca²⁺, and Mg²⁺ behaved similarly, with ΔH_{0%} of −71, −77, and −75 kJ/mol respectively. These values are essentially the same as that obtained by purging 0.1 M EEA in DMSO with CO₂ in the absence of any salt (−74 kJ/mol), where slight differences are due to minor amounts of carbamate formation with the salts present. This result indicates that these salts do not significantly perturb the stabilization of carbamic acid by DMSO. On the other hand, ΔH_{50%} (stabilization of carbamate) was sensitive to salt and became increasingly negative as the Lewis acidity of the cations increased from Li⁺ (ΔH_{50%}−26 kJ/mol) to Ca²⁺ (−48 kJ/mol) and Mg²⁺ (−50 kJ/mol), as also summarized in FIG. 8C. This can be rationalized by the fact that stronger Lewis acid cations have stronger electrostatic interactions with the carbamate anions.

In contrast to the other cations, Zn²⁺ exhibited unique behavior, where both ΔH_{0%} (−50 kJ/mol) and ΔH_{50%} (−27 kJ/mol) were less negative compared to the other cations. The reason behind the distinct ΔH_{0%} can be rationalized by Fourier transform infrared (FTIR) spectra of amine-free electrolytes containing only DMSO and 0.3 M of each salt, which allows for closer interrogation of the cation solvation environments (FIG. 8D). Among all cases, only the Zn electrolyte showed a distinct peak at 982 cm⁻¹, which has been reported to correspond to the S═O stretching vibration band of metal-DMSO complexes. It is therefore proposed that the strong Zn-DMSO interactions compete with hydrogen-bonded stabilization of the carbamic acid and underlie its projected relative destabilization (FIG. 8E). Such interactions also screen solvated Zn²⁺ interactions with carbamate, explaining the lower magnitude of ΔH_{50%}. Overall, ΔH_{conversion} (=ΔH_{50%}−ΔH_{0%}) was lowest and thus least endothermic for Zn²⁺ (22 kJ/mol, FIG. 8C) compared to Li⁺ (45 kJ/mol), Ca²⁺ (30 kJ/mol), and Mg²⁺ (25 kJ/mol), which aligns well with the rank of cation conversion efficiencies found above. Interestingly, this endothermic yet spontaneous carbamic acid-to-carbamate conversion (in the presence of salt) indicates that the conversion reaction is entropically driven in all cases.

### Electrochemical Cell Design and Testing of Cyclical CO₂ Capture/Release

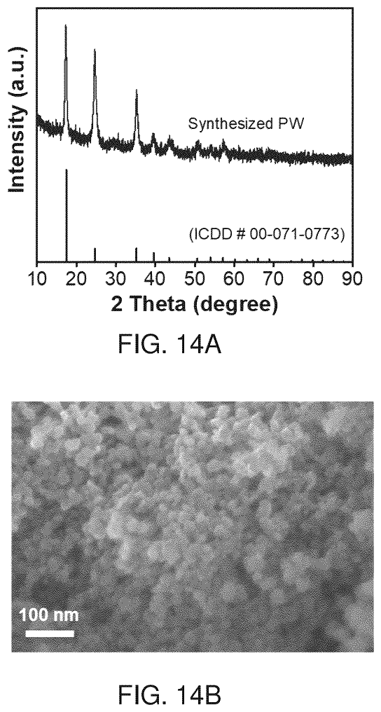

Based on the above results, an electrochemical K⁺—Zn²⁺ dual ion cell containing a PW cathode and Zn anode was conceived to realize the ion swing under electrochemical driving conditions. PW is a well-studied K⁺ intercalation material that attains facile (de)intercalation and cyclability in various electrolytes, thus was chosen as an exemplar K⁺ storage electrode (characterization in FIGS. 14A-14B). For the anode, Zn metal has been shown to have high and stable Columbic efficiency (CE) of >99% in DMSO-based electrolyte, supporting the use of Zn foil as the Zn²⁺ storage electrode. The electrolyte comprised an initially K⁺-rich solution with minor amounts of Zn²⁺, i.e., 0.5 M KTFSI+0.1 M Zn(TFSI)₂, with 0.5 M of EEA that had been pre-purged with CO₂ prior to cell assembly to avoid direct contact between lean amine and Zn metal (the cell atmosphere is also purged with CO₂). Note that Zn(TFSI)₂ was included in the electrolyte since the first cell charging requires Zn²⁺ plating from the electrolyte.

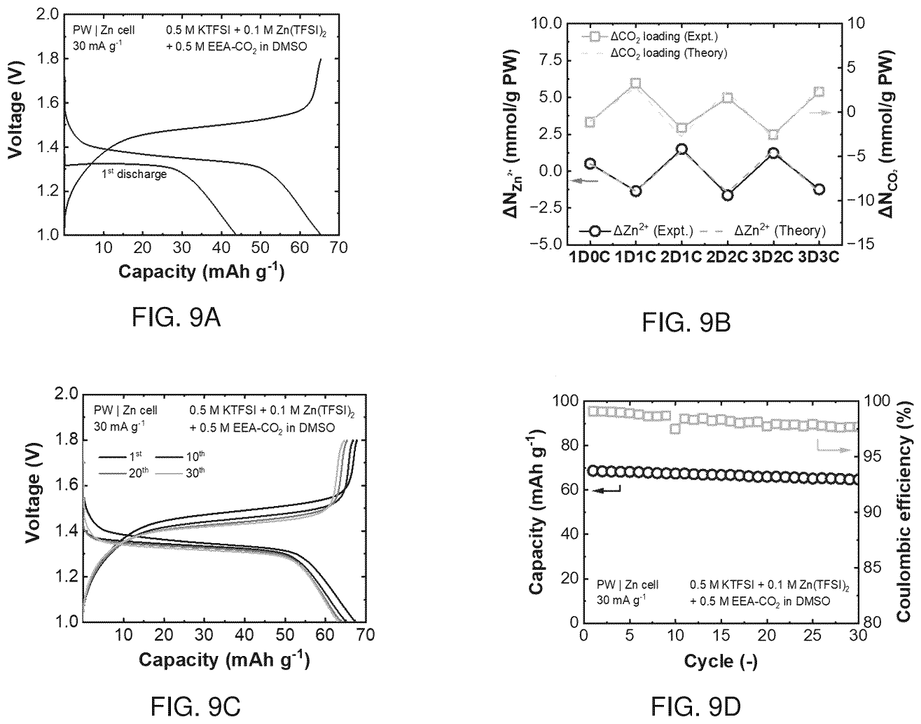

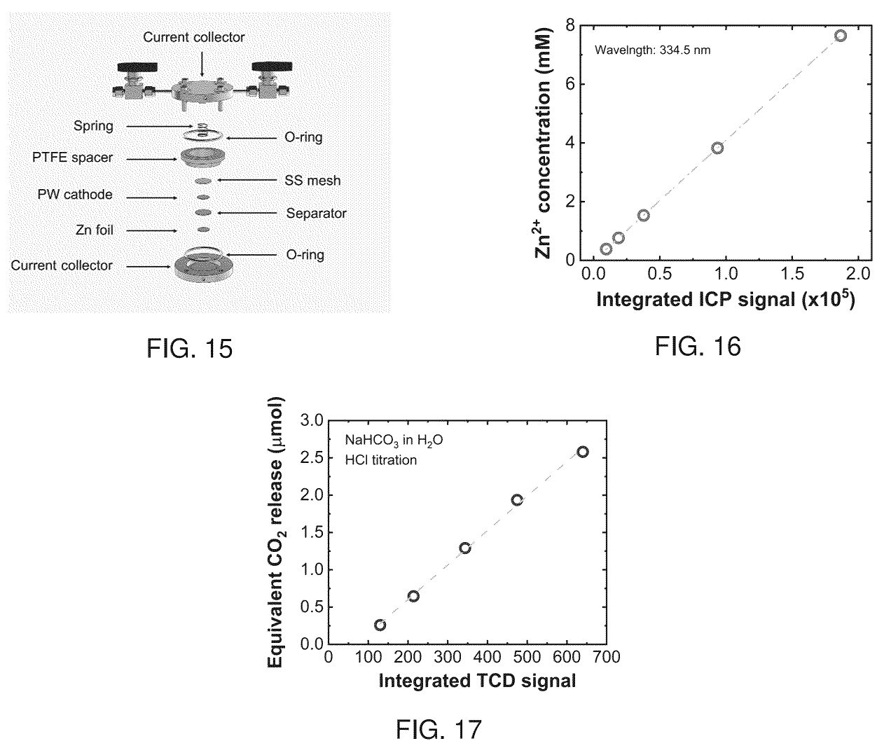

PW/Zn full cells were constructed with the above electrolyte to verify that the cation-swing process examined previously can be driven within an electrochemical cell. A custom two-electrode electrochemical cell outfitted with valves for headspace purging (FIG. 15) was used to maintain CO₂ headspace during cell cycling. FIG. 9A shows galvanostatic charge and discharge curves of the PW/Zn cell at a constant current of 30 mA g⁻¹ (normalized to the cathode mass). The cell, which was capacity-limited by the PW electrode, demonstrated an initial discharge capacity of 65 mAh g⁻¹. This capacity corresponds to the theoretical capacity of PW with 1 K⁺intercalation (78 mAh g⁻¹) when charged below 1.8 V, given that the second K⁺ intercalation which corresponds to the full of theoretical capacity 155 mAh g⁻¹—occurs at >2.0 V, which exceeds the anodic stability of DMSO.

It was next validated whether significant changes in Zn²⁺ concentration could be achieved in the dual-ion cell. To do so, a series of cells was cycled to varying states (1^{st} discharge, 1 full cycle, etc.). The electrolyte was then extracted for analysis by inductively coupled plasma-optical emission spectrometry (ICP-OES). Given the cell capacity of 65 mAh g⁻¹ PW, the expected amount of Zn²⁺ and CO₂ swing were 2.4 and 4.8 mmol g⁻¹ PW between charge and discharge states, assuming each Zn²⁺ modulated an additional 2 CO₂ release corresponding to 100% cation conversion efficiency. FIG. 9B confirms a clear linear increase and decrease as the Zn²⁺ concentration was cycled, which matched quantitatively with the theoretical values calculated based on the cell capacity. This result indicated the cation-swing process worked as expected to modulate the cation population in solution without significant side reactions. The changes of amine CO₂ loading over discharge/charge was also directly verified by extracting electrolyte from cells at different states, titrating with acid and quantifying the released CO₂ by GC, and agreed with the expected CO₂ loading changes based on changes of Zn²⁺. These findings provide evidence that altering the cation populations electrochemically drives CO₂ loading changes in the electrolyte.

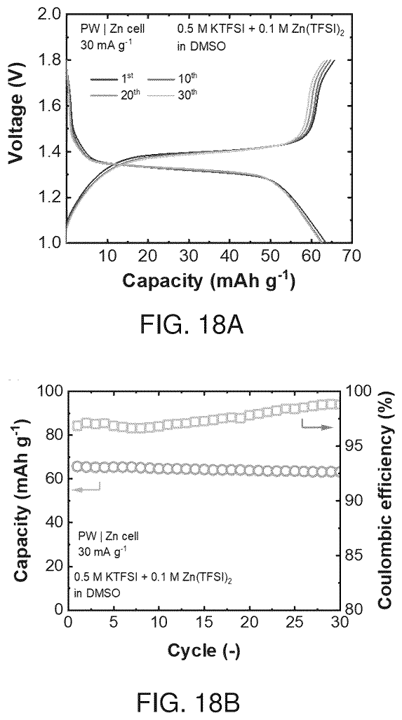

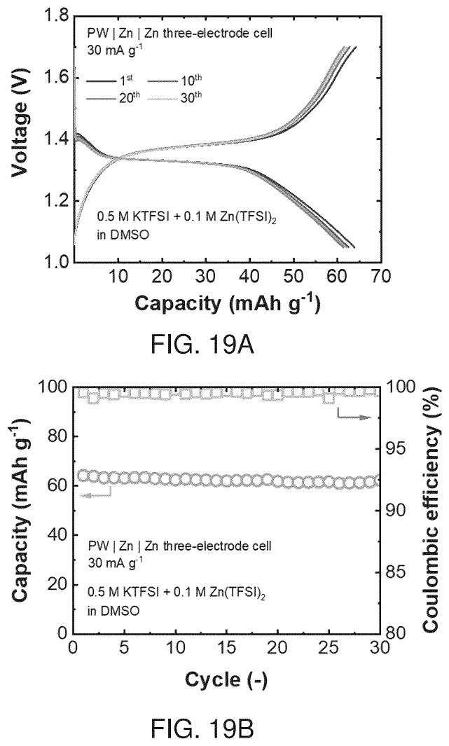

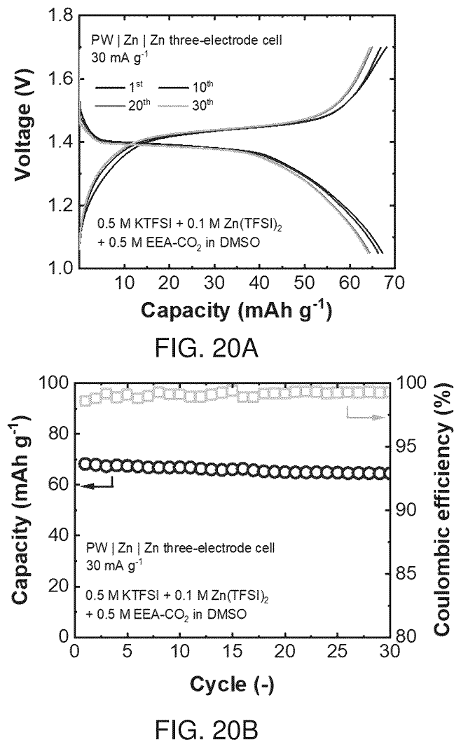

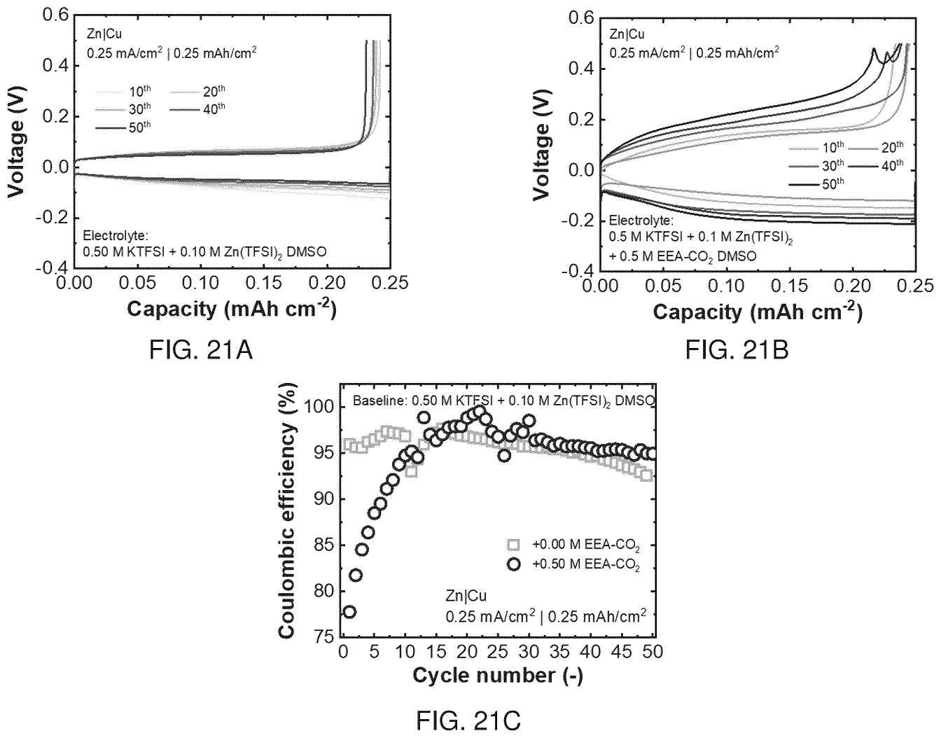

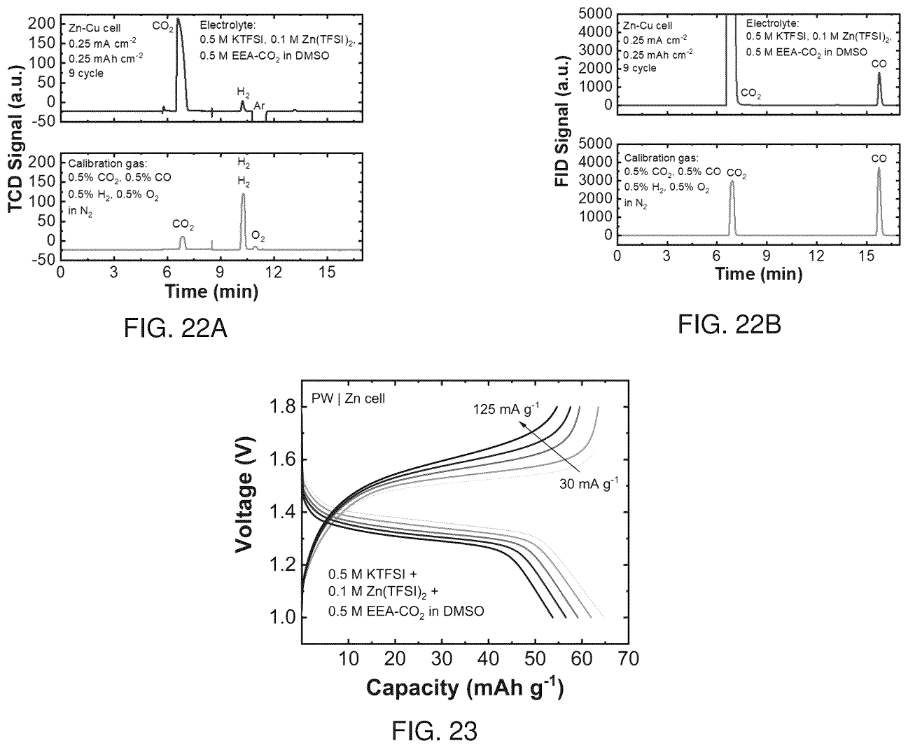

Finally, the long-term cycling performance of the PW/Zn cell was evaluated (FIG. 9C). With amines and CO₂ in the cell, 94.2% of capacity was retained after 30 cycles (FIG. 9D), which is similar to that of cells without amine (96.2%, FIGS. 18A-18B). A three-electrode cell (PW working electrode, Zn counter and reference electrodes) was used to probe the intrinsic cycling stability of the PW cathode without and with the amine-CO₂ in the electrolyte, which showed a capacity retention after 30 cycles of 96.9% and 94.5% (FIGS. 19A-20B), which are both similar to the capacity retention in the two-electrode PW/Zn cell. Two-electrode Zn/Cu cells were also examined and compared without and with amine (FIGS. 21A-21C). The average CEs from the 20th to the 50th cycle were 95.1% and 96.4% for 0.0 M and 0.5 M amine-containing cells, respectively; the only notable difference was a higher degree of plating/stripping polarization with amine present. No H₂ or CO evolution was confirmed by extracting the headspace gas from the cell for GC gas quantifications (FIGS. 22A-22B). The small capacity and cycling differences without and with amine in full cells might be hypothesized to arise from cell balancing and polarization differences when amine is included or omitted, which might lead to capacity slippage. Regardless, the good cycling performance indicates reasonable stability.

In conclusion, an electrochemical cation-swing process is described for CO₂ separation as a possible alternative to thermal regeneration as used with conventional amine scrubbing processes. The proof-of-concept system described in this example demonstrates the ability to reversibly modulate the CO₂ loading on amine under ambient conditions by electrochemically swinging the cation concentrations in the electrolyte between Zn²⁺ (discharge) and K⁺ (charge). The underlying principle of this process was shown to exploit a carbamic acid-to-carbamate conversion process driven by Zn²⁺ cations, where the role of Zn²⁺ in this system is to: (1) destabilize carbamic acid by reducing overall hydrogen bond strength from DMSO; and (2) stabilize carbamate by electrostatic interactions. The electrical energy of the cation-swing capture-release process reported herein was calculated to be ˜22-39 kJ/mol CO₂ at an equivalent areal current of 0.1-0.5 mA cm⁻². This value is on par with those of other early-stage electrochemical processes (e.g., −33 kJ/mol CO₂ at ˜0.25 mA cm⁻² for proton concentration process and −56 kJ/mol CO₂ at ˜0.5 mA cm⁻² for quinone chemistry).

### Example 2

The following examples describes the materials and methods used in the dual salt cation-swing process for electrochemical CO₂ separation.

Materials: Zinc foil (99.9% polycrystalline metallic foil, MTI) and 2-ethoxyethylamine (98%, TCI America) were used as received and stored in the glovebox (H₂O content <1 ppm, O₂ content <1 ppm, MBRAUN). KTFSI (99.5%, Solvionic), LiTFSI (99.99% trace metals basis, Sigma-Aldrich), Ca(TFSI)₂ (99.5%, Solvionic), Mg(TFSI)₂ (99.5%, Solvionic), Zn(TFSI)₂ (99.5%, Solvionic), and Whatman filter paper (grade GF/F, Sigma Aldrich) were dried in a Buchi glass oven under active vacuum overnight at 120° C. before transfer to the glovebox. 4A molecular sieves (bead size 8-12 mesh, Sigma-Aldrich) were activated in the Buchi glass oven under active vacuum for 24 hours at 250° C. DMSO (anhydrous, >99.9%, Sigma-Aldrich) and DMSO-d₆ (99.9 atom % D, Sigma-Aldrich) were dried with 20 vol. % activated 4A molecular sieves for two days before use. All amine, solvents, and salts were stored inside the glovebox at room temperature.

¹H Nuclear Magnetic Resonance (NMR) Spectroscopy: ¹H NMR measurements were performed using a three-channel Bruker Avance Neo spectrometer (500 MHz), equipped with a 5 mm liquid-nitrogen cooled Prodigy broad band observe (BBO) cryoprobe. All samples were prepared with DMSO-d₆ as the deuterated solvent inside the glovebox and loaded in a capped Wilmad NMR tube (700 μl).

Reaction Microcalorimetry Experiments and Analysis: Experiments were performed using a Micro Reaction Calorimeter (uRC™, Thermal Hazard Technology) equipped with a gas flow option. In a typical experiment, 0.7 ml of electrolyte comprising 0.1 M EEA and the desired concentration of salt in DMSO-d₆ was loaded into a 1.5 ml stainless-steel vial connected with two 1/16″ tubes as the inlet (with an inline flow controller to purge CO₂) and outlet (vent). After loading the vial into the calorimeter, the vial equilibrated until the temperature converges to 25° C. and signal fluctuation is within 0.01 mW. Subsequently, CO₂ was purged at a flow rate of 1 sccm controlled by the flow controller, and the resulting signal was collected until the heat returned to baseline, indicating saturation. The integrated peak gave the enthalpy of reaction. The speciation of EEA-CO₂ adducts were measured by ¹H NMR immediately following the calorimetry experiments. A series of enthalpy versus carbamate conversion using the same salt allowed for fitting of a line through the data points, and the intercept at projected carbamate conversions of 0% and 50% were ΔH_{0%} and ΔH_{50%}.

Fourier-Transform Infrared Spectroscopy (FTIR): The desired liquid sample was used for FTIR measurements on a Nicolet iS50 FT-IR spectrometer (Thermo Scientific). All measurements were performed in the transmission mode over a wavenumber range of 400 to 4000 cm⁻¹ by ATR using a diamond crystal.

PW Synthesis and Electrode Preparation: Briefly, 1.67 g (6 mmol) of iron sulfate pentahydrate and 25 g of potassium citrate were dissolved in a 500 ml beaker with 100 ml deionized water while N₂ was bubbled at a flow rate of 100 sccm to remove the dissolve O₂. 1.689 g (4 mmol) of potassium hexacyanoferrate(II) trihydrate was dissolved in another beaker with 100 ml deionized water, and was slowly added into the iron sulfate solution while stirring. The mixture was stirred at room temperature overnight with continuous N₂ bubbling. Next, the precipitate was collected by centrifuge and washed with DI water to remove the unreacted reactants. This process was repeated three times to ensure no residual impurities. Finally, the clean product was dried under active vacuum at 100° C. overnight. To prepare the PW cathodes, a slurry with 70 wt. % PW, 20 wt. % Super P, and 10 wt. % polyvinylidene fluoride (PVDF) were mixed in NMP and then coated on Toray paper (060, wet-proofed, Fuel Cell store) using a doctor blade technique. The obtained PW-coated Toray paper was punched into circular disks (15 mm diameter) and then dried in a Buchi glass oven under vacuum at 100° C. overnight. Typical active material loadings were 2.5-4.0 mg/cm².

Full-cell Performance Measurement: Custom two-electrode electrochemical cells were outfitted with valves to enable headspace sampling (FIG. 15). Cells consisted of a 15 mm PW electrode, two 18 mm Whatman glass fiber separators, 250 μL of electrolyte, a 15 mm Zn electrode, a stainless-steel (316) mesh, and a spring. The electrolyte was 0.5 M KTFSI, 0.1 M Zn(TFSI)₂, and 0.0 M/0.5 M EEA-CO₂ in DMSO (electrolyte with amine is purged with CO₂ prior to being loaded into the cell). Assembled cells were rested for 6 hours before testing. Galvanostatic cycling was performed at 30 mA g⁻¹ from 1.0 V-1.8 V. All electrochemical experiments were conducted on BioLogic or Neware Battery Tester channels.

PW Half-cell Performance Measurement: A glass three-electrode cell (Pine Research, Low Volume Cell) was used. The PW working electrode was prepared as described above, and two pieces of Zn foil were used as reference and counter electrodes, respectively. Cells were rested for 6 hours before testing. The open-circuit voltage (OCV) after 6 hours resting is approximately 1.4 V vs Zn/Zn²⁺. Galvanostatic charge and discharge was performed at 30 mA g⁻¹ from 1.05 V-1.70 V vs Zn/Zn²⁺. All electrochemical experiments were conducted on BioLogic channels.

Zn Anode Reversibility Test: Custom two-electrode electrochemical cells were outfitted with valves to enable headspace sampling (FIG. 15). Cells consisted of a 15 mm Cu electrode, two 18 mm Whatman glass fiber separators, 250 μL of electrolyte, a 15 mm Zn electrode, a stainless-steel (316) mesh, and a spring. Assembled cells were rested for 6 hours before testing. Cells with EEA in the electrolyte were purged with CO₂ to maintain a CO₂ headspace before resting. Galvanostatic cycling experiments were conducted at 0.25 mA/cm² for 1 hour (capacity of 0.25 mAh/cm²), with a charging (stripping) cutoff voltage of 1 V. After each half cycle, the cell rested at OCV for 5 minutes. Electrochemical experiments were conducted using BioLogic or Neware Battery Tester channels.

Calculation of Carbamic Acid-to-Carbamate Conversion Extent by ¹H NMR Spectra: Desired amounts of EEA and electrolyte salt were dissolved in DMSO-d₆, and then the as-prepared electrolyte was purged with CO₂ to form EEA-CO₂ adducts. Then, Ar was used to purge the vial headspace briefly before opening the vial and transferring 700 μL of the electrolyte to a NMR tube inside the glovebox at the indicated sampling time. In a typical ¹H NMR spectra (FIG. 10), there were two well-separated peaks at high chemical shift which could be used for quantifying the proportion of carbamic acid, carbamate, and ammonium. The peak located around 6 ppm is the proton peak of —NH—C— from both carbamic acid and carbamate. The other peak located between 7 and 10 ppm, depending on the electrolyte salt, is the proton peak of —COOH from carbamic acid in fast exchange with the —NH₃⁺ peak.

x and x′ were assumed to be the number of amide protons in carbamic acid (R—NHCOOH) and carbamic acid protons (R—NHCOOH), respectively. Then, y and y′ were assumed to be the number of amide protons in carbamate (R—NHCOO⁻) and the protons in the ammonium cation (R—NH₃⁺), respectively:
x: R—NHCOOH
x′: R—NHCOOH
y: R—NHCOO⁻
y′: R—NH₃⁺

With these assumptions, the equation for the total amount of protons in peaks at 6 ppm and 7-10 ppm, respectively, was determined. For demonstration, the number of protons at 6 and 7-10 ppm were assumed to be a and b, respectively:

$$x + y = a$$

$$x ’ + y ’ = b$$

In addition to the above equations, it is also known that: (1) the amount of amide proton in carbamic acid (R—NHCOOH) equals the number of carbamic acid protons (R—NHCOOH); and (2) the molar quantities of ammonium and carbamate are the same in the electrolyte:

$$x = x ’$$

$$y ’ = 3 y$$

The latter follows because of the three-fold higher number of protons in y′ than x′. By solving the above equations, one obtains

$$x = x ’ = \frac{3 a - b}{2} , and y = \frac{b - a}{2} .$$

Here, the carbamate conversion was defined by the equilibrium proportion of carbamate in the electrolyte

$$( \frac{y}{x + y + {y}^{′} / 3} ) ,$$

where 50% represents a full conversion of this reaction. With this definition, carbamate conversion was obtained as

$$\frac{b - a}{a + b} ( = \frac{b / a - 1}{1 + b / a} ) .$$

Additionally, the total CO₂ loading is defined as the ratio of carbamate+carbamic acid to the total amine concentration

$$( \frac{x + y}{x + y + {y}^{′} / 3} ) .$$

Table 1 tabulates ratios of peak area at 10 ppm to that at 6 ppm

$$( \frac{b}{a} )$$

and their corresponding carbamate conversions and CO₂ loading.

TABLE 1
Carbamate conversion and CO₂ loading on amine as a function of
ratio of peak area at 10 ppm to that at 6 ppm.

| $Peak area ratio ( \frac{b}{a} )$ | Carbamate conversion (%) | CO₂ loading (CO₂ per amine) |
|---|---|---|
| 1 | 0.0 | 1.00 |
| 1.25 | 11 | 0.89 |
| 1.5 | 20 | 0.80 |
| 1.75 | 27 | 0.73 |
| 2 | 33 | 0.67 |
| 2.25 | 38 | 0.62 |
| 2.5 | 43 | 0.57 |
| 2.75 | 47 | 0.53 |
| 3 | 50 | 0.50 |

Effect of Different Sample Preparation Procedures on Carbamate Conversion: For a standard ¹H NMR sample preparation, CO₂ was bubbled into the electrolyte containing the desired amounts of amine and salt in a gas-tight vial to form amine-CO₂ adducts. Subsequently, the vial headspace was purged briefly with Ar to remove headspace CO₂ prior to opening the vial for electrolyte transfer into an NMR tube, which can otherwise contaminate the glovebox. The subsequently measured carbamate conversion by ¹H NMR was noticeably affected by the sample preparation procedure, especially Ar purge time and Ar purge rate, even for controlled amine and salt concentrations in the electrolyte. Different CO₂ purge times were first examined, and the results indicated little effect on carbamate conversion provided enough CO₂ was purged to saturate the electrolyte (typically only ˜1 min. needed, FIG. 11, left). However, longer Ar purge times increased carbamate conversion significantly (FIG. 11, right). This is because purging Ar removes physically dissolved CO₂ in the electrolyte, which is at relatively high concentration in nonaqueous solvent (e.g., 0.14 M for DMSO), thus shifting the below equilibrium from carbamic acid to increased ammonium carbamate and decreasing the measured total CO₂ loading on amine. Note that the same effect is observed if Ar is purged with faster flow rates.

$$2 R - NHCOOH ↔ {RNHCOO}^{-} + {RNH}_{3}^{+} + {CO}_{2}$$

If the electrolyte is not saturated with CO₂ before injecting cations due to long/strong Ar purge in ¹H NMR sample preparation, part of the carbamate conversion would be attributed to the equilibrium shift as discussed above instead of cation-induced conversion. This would lead to the overestimation of the cation efficiencies. Therefore, all the Ar purging times (1 minute) and rates (100 sccm) were minimized to prevent this equilibrium shift.

Calculation of the Total Amount of CO₂ Released Due to Electrolyte Injection into Saturated Carbamic Acid Solutions: In a typical experiment, an electrolyte containing 0.5 M KTFSI/0.5 M EEA in DMSO was loaded in a gas-tight vial (SureSTART™ 10 mL glass screw top headspace vials). A needle/tubing apparatus connected to upstream CO₂ and N₂ gas flow controllers (Alicat Scientific) was plugged through the septum into the electrolyte. A second needle/tubing apparatus provided gas outflow to a CO₂ sensor (SprintlR®—W 100% CO₂ sensor). CO₂ gas flowed at 100 sccm to purge the amine electrolyte with CO₂ for 5 minutes (CO₂ loading: 0.91 CO₂ per EEA). Then, N₂ gas flowed in at 200 sccm while an electrolyte containing 0.5 M Zn(TFSI)₂/0.5 M EEA-CO₂ in DMSO was injected by syringe into the vial. The same experiment was repeated by injecting electrolyte with 0.5 M KTFSI and 0.5 M EEA-CO₂ in DMSO (i.e., no Zn(TFSI)₂) to get the baseline CO₂ change due to injection of the same solution. Note that since the initial electrolyte is purged with CO₂, the baseline headspace CO₂ concentration is high and gradually reduced while purging N₂ during the experiment. This experiment was then repeated for different amount of injected Zn(TFSI)₂ (FIGS. 13A-13F). The initial and final concentrations of KTFSI and Zn(TFSI)₂ in each case are listed in Table 2, with the total final electrolyte volume was fixed at 5 mL.

TABLE 2
The amounts of initial 0.5M KTFSI + 0.5M EEA-CO₂ in DMSO (KTFSI electrolyte)
in the vial, the amounts of injected 0.5M Zn(TFSI)₂ + 0.5M EEA-CO₂ in DMSO (Zn(TFSI)₂
electrolyte), and their corresponding final K⁺ and Zn²⁺ concentration. Total amine concentration
and electrolyte volume were fixed at 0.5M and 5 mL, respectively.

| Initial | Injected | | | | | |
|---|---|---|---|---|---|---|
| KTFSI | Zn(TFSI)₂ | Final K⁺ | Final Zn²⁺ | Total cation | Total amine | Zn/amine |
| electrolyte | electrolyte | concentration | concentration | concentration | concentration | molar |
| (mL) | (mL) | (M) | (M) | (M) | (M) | ratio |
| 4.75 | 0.25 | 0.475 | 0.025 | 0.50 | 0.50 | 0.05 |
| 4.50 | 0.50 | 0.450 | 0.050 | 0.50 | 0.50 | 0.10 |
| 4.25 | 0.75 | 0.425 | 0.075 | 0.50 | 0.50 | 0.15 |
| 4.00 | 1.00 | 0.400 | 0.100 | 0.50 | 0.50 | 0.20 |
| 3.50 | 1.50 | 0.350 | 0.150 | 0.50 | 0.50 | 0.30 |
| 3.00 | 2.00 | 0.300 | 0.200 | 0.50 | 0.50 | 0.40 |

After obtaining the peak area of each condition, the amount of CO₂ release per mol of EEA was calculated by the following formula:

$${x}_{{CO}_{2}} = \frac{P {\dot{V}}_{{N}_{2}} {A}_{peak}}{RT {n}_{EEA}} \qquad ( S 5 )$$

where x_{CO}_{₂} is the mol of CO₂ release per mol EEA, P is the pressure reading on the flow controller, \dot{V}_{N}_{₂} is the total volumetric flow rate of gas set by the mass flow controller (200 sccm), Aₚₑₐₖ is the integrated peak area from the experimental data, R is the ideal gas constant, T is the temperature, and n_{EEA} is the total amount of EEA in the final electrolyte (2.5 mmol). The expected mol of CO₂ release per mol EEA is determined as follows: (1) CO₂ loading on amines with the same set of K⁺ and Zn²⁺ concentrations was quantified with ¹H NMR, as shown in Table 3; and (2) the difference between the CO₂ loading with a given Zn²⁺ concentration and that of 0.00 M Zn²⁺ concentration (0.91) indicated an expected CO₂ release, which is plotted as the dashed line in FIG. 7C. This calculation assumes that, despite the presence of K⁺ in solution, the speciation is determined entirely by Zn²⁺ concentration. Note that the CO₂ loading for 0.025 and 0.075 M Zn²⁺ were determined by interpolating the CO₂ loading from samples with adjacent concentrations from the NMR data.

TABLE 3
CO₂ loading of 0.5M EEA-CO₂ in DMSO (quantified by ¹H NMR)
in the presence of different concentrations of K⁺ and Zn²⁺
(total cation concentration: 0.5M). This set of data
simulated cation swing between K⁺ and Zn²⁺ and
obtained the corresponding CO₂ loading on
amines, shown as the dashed line in FIG. 7C.

| Final K⁺ | Zn²⁺ | CO₂ loading |
|---|---|---|
| concentration | concentration | (mol CO₂/mol |
| (M) | (M) | amine) |
| 0.50 | 0.00 | 0.91 |
| 0.45 | 0.05 | 0.70 |
| 0.40 | 0.10 | 0.53 |
| 0.35 | 0.15 | 0.50 |
| 0.30 | 0.20 | 0.50 |
| 0.25 | 0.25 | 0.50 |

Inductively Coupled Plasma—Optical Emission Spectrometry (ICP-OES) Measurements: To prepare ICP samples, the cell was opened after cycling to a specific state and the PW cathode, separator, and Zn foil were soaked in DMSO for 3 hours. Subsequently, the DMSO solution was filtered with a syringe filter (polytetrafluoroethylene with 0.22 μm pore size, VWR) to remove any solids, then the filtrate was mixed with a 3 wt. % nitric acid (HNO₃) solution to a final composition of 10 vol. % of DMSO and 90 vol. % of 3 wt. % HNO₃ solution. ICP-OES experiments were performed in an Agilent 5100 VDV spectrometer with an argon plasma in radial viewing mode. A zinc standard (1000 mg/L Zn in nitric acid, Sigma-Aldrich) for ICP was used to generate the calibration curves based on the observed signal at 334.5 nm.

The theoretical change of Zn²⁺ concentration (ΔC_{Zn}_{²⁺}) in the electrolyte at each step of cell charge or discharge was calculated as follows:

$$Δ {C}_{Z {n}^{2 +}} = \frac{- Δ Q}{n F {V}_{electrolyte}}$$

where ΔQ is the charge passed into the Zn anode compared to previous step (C), n is the cation charge (n=2 for Zn²⁺), F is the Faraday constant (96485 C/mol), and V_{electrolyte} is the electrolyte volume in the cell (=250 μL). Since the material loadings on PW cathode can vary, ΔC_{Zn}_{²⁺} is then normalized by PW loading for comparison in FIG. 9B.

Quantification of CO₂ Loading on Amine by Gas Chromatography (GC): Full cells were charged or discharged to a specific point, then disassembled under air atmosphere. Subsequently, 5 μl of the electrolyte was squeezed out from the separator and put into a gas-tight vial (SureSTART™ 10 mL Glass Screw Top Headspace Vials, Thermo Fisher Scientific). Then, excess amounts of 37 wt. % hydrochloric acid (HCl) (0.2 ml) were injected into the vial to stimulate the CO₂ release from the amine. A sample of the vial headspace was extracted by a gas tight syringe (Luer Lock, Sigma) with a push-button syringe valve (Sigma) 20 minutes after the acid injection to allow the headspace to reach equilibrium. The gas in the syringe was then injected to an Agilent 7890B chromatograph with a flame ionization detector (FID) and a thermal conductivity detector (TCD). The CO₂ signal showed up ˜6.7 minutes after the injection and the calibration of the TCD detectors for CO₂ were performed by using sodium bicarbonate (NaHCO₃) as the external standard. Briefly, standard solutions of 5, 12.5, 25, 37.5, and 50 mM of NaHCO₃ in H₂O were prepared and 50 μL of each standard solution were sealed in gas-tight vials and injected with 0.2 ml 37 wt. % HCl. Upon reaction with acid, NaHCO₃ releases CO₂ stoichiometrically (NaHCO₃+H⁺→Na⁺+H₂O+CO₂), thus allowing a linear calibration of the CO₂ TCD signals with the known amount of CO₂ in the vial headspace (FIG. 17). Note that the calibration line does not pass through the origin since the samples are made under atmosphere. Therefore, a background CO₂ concentration (˜450 ppm) was recorded.

To get the experimental change of CO₂ loaded on amine (ΔN_{CO2}), the obtained CO₂ release for each step was compared to its previous step. To calculate the theoretical CO₂ change, the change of Zn²⁺ concentration upon a given discharge or charge step was calculated based on the cell capacity assuming that every Zn²⁺ induces 2 CO₂ molecules to be released (4 RNHCOOH+Zn²⁺→2(RNHCOO⁻)Zn²⁺+RNH₃⁺+2 CO₂).

In the electrolyte with EEA-CO₂, carbamic acid and ammonium can participate in the hydrogen evolution reaction (HER), and physically dissolved CO₂ could be potentially reduced to form CO (CO₂RR), leading to capacity loss. To assess possible amounts of H₂ and CO evolution during cell cycling, the headspace gas of Zn/Cu cell containing 0.5 M EEA-CO₂ (conditions: current 0.25 mA/cm², capacity 0.25 mAh/cm², and 9 plating+stripping cycles) was extracted and injected into the GC to get the headspace gas concentration (FIGS. 22A-22B), which was calculated as follows:

$$\frac{{C}_{headspace}}{{A}_{headspace}} = \frac{{C}_{calibration}}{{A}_{calibration}}$$

where C and A are the concentration of gas (H₂ or CO) and the integrated peak area (TCD for H₂ or FID for CO) in either the headspace of the cell or calibration gas, respectively. Then, the charge corresponding to HER (Q_{H}_{₂}) and CO₂RR (Q_{CO}) was calculated by

$$\begin{matrix}{Q}_{{H}_{2}} = \frac{{PC}_{{H}_{2} , headspace} {V}_{headspace}}{R T} \times n F \\ {Q}_{CO} = \frac{{PC}_{CO , headspace} {V}_{headspace}}{R T} \times n F\end{matrix}$$

where P is the pressure (1 atm), V_{headspace} is the headspace volume of the custom cell (4.0 ml), R is the ideal gas constant, T is the temperature (25° C.), n is the number of electron per mol H₂ or CO forming (n=2 for both cases), F is the Faradaic constant (96485 C/mol). Q_{H}_{₂} and Q_{CO} are then calculated to be 0.02 C and 0.06 C, respectively, which corresponds to less than 0.01% and 0.04% of the charge loss. Therefore, it was confirmed that the capacity loss is not from HER and CO₂RR.

Energy Requirement and Areal CO₂ Release Rate Estimation: Energy requirements were calculated based on the charge and discharge curves of the full cell (FIG. 23). The system consumes energy upon charge to reach the CO₂ loaded state; upon cell reversal, energy is released galvanically upon discharge while CO₂ is released. The energy consumption for one cycle is the energy difference between charging and discharging the cell. As for the total amount of CO₂ released, the total amount of Zn²⁺ swing was calculated based on the capacity of the cell assuming that every Zn²⁺ could modulate 1.5 CO₂ release (this assumption is based the CO₂ loading change between 2D1C and 2D2C in FIG. 9B). Using the charge and discharge curves from FIG. 23 at different rates, the energy consumption for cation-swing process were estimated and tabulated in Table 4.

TABLE 4
Estimated energy consumption for the cation-swing process
under different current density.

| | | Energy | Energy | CO₂ | Estimated |
|---|---|---|---|---|---|
| Current | Current | consumed | released | released | energy |
| rate | density | during | during | (mmol | consumption |
| (mA | (mA | charging | discharging | g⁻¹ | (kJ/mol |
| g⁻¹) | cm⁻²) | (J g⁻¹ PW) | (J g⁻¹ PW) | PW) | CO₂) |
| 30 | 0.12 | 351 | 311 | 1.81 | 22.1 |
| 50 | 0.20 | 345 | 294 | 1.74 | 29.6 |
| 75 | 0.30 | 328 | 277 | 1.66 | 30.8 |
| 100 | 0.40 | 321 | 263 | 1.58 | 36.5 |
| 125 | 0.50 | 307 | 247 | 1.50 | 39.4 |

### Example 3

The following examples describes the advantages and improvements of the dual salt cation-swing process for electrochemical CO₂ separation over conventional CO₂ separation technologies.

The conventional industrial carbon capture technology is the amine scrubbing process. The amine scrubbing process relies on aqueous amine solutions as the sorbent to react with CO₂ from the flue gas in the absorber. After capturing CO₂, the resulting CO₂-rich amine is routed to a stripper column. It is then regenerated at 100-150° C. and recycled back to the absorber column for the next CO₂ capture cycle. Separated CO₂ in the gas phase is usually compressed, followed by sequestration or utilization.

There are several shortcomings related to the conventional amine scrubbing process that suggest the need for a paradigm shift in carbon capture methods. The regeneration step, for example, results in heating extensive amounts of water solutions to 100-150° C. and creates large energy consumption for the process, which can take up to 20-30% of a power plant's generation capacity. The conventional amine scrubbing process also requires at least 60 kJ mol⁻¹ CO₂ while the theoretical energy requirement for CO₂ separation is only 7 kJ mol⁻¹ CO₂. In addition to the energy penalty, amine degradation under high temperatures also causes performance decay, extra capital costs, equipment corrosion, generation of low vapor pressure products, and environmental issues.

Given these constraints, there has been growing interest in electrochemical swing processes, which adopt various strategies to toggle the loading state of a sorbent electrochemically rather than thermally. These approaches include: (i) the direct redox process; (ii) the EMAR system; (iii) the proton concentration process; and (iv) bipolar membrane electrodialysis (BPMED). The direct redox process activates redox-active organics (e.g., quinones, disulfides, and bipyridines) at the cathode as nucleophiles to bind with CO₂ and regenerates them at the anode for CO₂ release. The EMAR system utilizes Cu²⁺ to displace CO₂ from loaded amines by forming strong Cu²⁺-amine complexes, allowing CO₂ release under ambient conditions. The Cu²⁺ can then be plated from the amine-complexed state to return the amine to its original state. Upon cyclical electrochemical stripping/plating of Cu electrodes in the anode/cathode chambers, respectively, the concentrations of Cu²⁺ are reversibly swung, enabling the modulation of different CO₂ loadings on amines. The proton concentration process (also called pH swing process) intercalates protons electrochemically into an H⁺ storage material (e.g., MnO₂) to increase the pH of the electrolyte, such that dissolved CO₂ can be captured by forming (bi)carbonate (HCO₃⁻ or CO₃²⁻). Afterwards, protons are de-intercalated to lower the pH of the electrolyte, shifting the equilibrium back to regenerate free CO₂. By charging/discharging a cell in this manner, CO₂ is cyclically absorbed/released. This system does not contain CO₂-binding sorbents in the electrolyte. Rather, it exploits CO₂ solubility and its chemical state in water by electrochemically changing pH. The BPMED process employs the same concept of swinging CO₂ equilibria in aqueous solutions as the pH swing process does. Instead of intercalating/de-intercalating protons, however, the BPMED process applies voltage for water splitting to allow the bipolar membrane to split water to H⁺ and OH⁻ and deliver them to different electrolyte chambers for CO₂ regeneration (anodic chamber) and capture (cathodic chamber).

The dual salt cation-swing process for electrochemical CO₂ separation exhibits the following advantages:

Lower energy requirement compared to thermal regeneration: The dual salt cation-swing process for electrochemical CO₂ separation revealed an energy requirement of ˜37.8 kJ/mol CO₂, which is significantly lower than that of the amine scrubbing process (>60 kJ/mol CO₂) and is on par with those of other electrochemical processes mentioned above (direct redox: 43 kJ/mol CO₂, EMAR: 35 kJ/mol CO₂, pH swing: 33 kJ/mol CO₂).

Reduced amine degradation: The conventional high-temperature thermal regeneration process can lead to severe amine degradation. The dual salt cation-swing process can work efficiently at room temperature, thus preventing the amine degradation at high temperature.

Potential integration with renewables for negative-emission: The conventional amine scrubbing process burns fossil fuels to create high-temperature steam and uses it to heat up the regeneration tower. The dual cation-swing process is an electrically-driven process, so clean renewable energy can be used as the only power source to drive this process, therefore enabling negative emissions more efficiently.

Modular design: Since the dual cation-swing process can operate under ambient conditions using electricity as the driving force, the process can be utilized beyond emissions-producing sites that co-produce high-temperature steam. Thus, the design relaxes the need for capital-intensive infrastructures, which are unachievable for conventional industrial amine scrubbing processes where the scale of the capture unit is dictated by the scale of flue gas production and steam generation. Also, without the need of the stripper column, the dual cation-swing process can be implemented with a modular design. Possible applications include, e.g., unit industrial processes (cement, ethylene, other chemical production), home/residential CO₂ capture, or mobile applications (cars, heavy-duty vehicles).

The dual salt cation-swing process for electrochemical CO₂ separation can be implemented in the following commercial applications.

Post-combustion CO₂ capture from power plant flue gases: As previously described, the conventional amine scrubbing has been employed in several power plants for post-combustion CO₂ capture process, but it suffers from a significant energy penalty of the high-temperature amine regeneration step. The dual salt cation-swing process regenerates amines using strong Lewis acid cations at ambient conditions, which significantly decreases the energy requirement of the process. The dual salt cation-swing process may therefore be employed as an alternative for the amine scrubbing process, providing a more energy-efficient CO₂ separation.

CO₂ capture for vehicle exhaust or residential buildings: The dual salt cation-swing system can be designed to function as “plug-and-play” devices in small-scale applications. For example, the dual cation-swing system can be implemented in vehicle exhaust lines or in residential buildings for CO₂ capture. When plugged in, the devices are in the charge state, and the amine sorbents are able to catch CO₂ emitting from the sources. Alternatively, CO₂ uptake can be conducted throughout the charging process (e.g., coupled with regenerative braking in a vehicle). Once the amines are fully loaded with CO₂, the devices can be unplugged and sent to a center to collect the concentrated CO₂ by discharging the devices. Finally, the devices could be charged and distributed to the users for next usage (or can be charged during use).

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. An electrochemical system, comprising:
a salt comprising a first Lewis acid cation;
a carbamic acid compound; and
an electrochemical cell comprising an electrode, wherein, upon discharge or charge of the electrochemical cell, the electrode is configured to produce a second Lewis acid cation that interacts with the carbamic acid compound to release CO₂ from the carbamic acid compound, and wherein the second Lewis acid cation is a stronger Lewis acid than the first Lewis acid cation.

2. The electrochemical system of claim 1, wherein the electrode is a negative electrode, and the electrochemical cell further comprises a positive electrode.

3. The electrochemical system of claim 1, wherein the salt is an electrolyte salt.

4. An electrochemical system, comprising:
a fluid source comprising:
an electrolyte salt comprising a first Lewis acid cation; and
a carbamic acid compound; and
an electrochemical cell comprising a positive electrode and a negative electrode, wherein, upon discharge of the electrochemical cell, the negative electrode is configured to produce a second Lewis acid cation that interacts with the carbamic acid compound to release CO₂ from the carbamic acid compound, thereby separating CO₂ from the fluid source, and wherein the second Lewis acid cation is a stronger Lewis acid that the first Lewis acid cation.

5. The electrochemical system of claim 2, wherein, upon discharge of the electrochemical cell, the positive electrode is configured to intercalate the first Lewis acid cation.

6. The electrochemical system of claim 2, wherein the positive electrode comprises Prussian white (PW), Prussian blue, and/or analogues thereof.

7. The electrochemical system of claim 2, wherein the negative electrode comprises a metal.

8. The electrochemical system of claim 7, wherein the metal comprises zinc (Zn), magnesium (Mg), calcium (Ca), and/or combinations thereof.

9. The electrochemical system of claim 1, wherein the second Lewis acid cation is Zn²⁺, Mg²⁺, Ca²⁺, and/or combinations thereof.

10. The electrochemical system of claim 4, wherein the fluid source comprises a nonaqueous solvent.

11. The electrochemical system of claim 10, wherein the nonaqueous solvent comprises dimethyl sulfoxide (DMSO), dimethylacetamide (DMA), N-methylpyrrolidone (NMP), and/or combinations thereof.

12. The electrochemical system of claim 3, wherein the electrolyte salt comprises a potassium (K)-containing salt, a sodium (Na)-containing salt, a lithium (Li)-containing salt, a cesium (Cs)-containing salt, and/or combinations thereof.

13. The electrochemical system of claim 3, wherein the electrolyte salt comprises the second Lewis acid cation.

14. The electrochemical system of claim 3, wherein the electrolyte salt comprises a Zn-containing salt, a Mg-containing salt, a Ca-containing salt, and/or combinations thereof.

15. The electrochemical system of claim 1, wherein the first Lewis acid cation is K⁺, Na⁺, Li⁺, Cs⁺, and/or combinations thereof.

16. The electrochemical cell of claim 1, wherein the carbamic acid compound is a compound of the formula (R¹)₂NCOOH,
wherein:
each R¹ is the same or different and is selected from the group consisting of hydrogen, deuterium, —C₁-C₁₀ alkyl, —C₂-C₁₀ alkenyl, —C₃-C₁₀ alkynyl, —C₃-C₁₀ cycloalkyl, and —R²—O—R², and
each R² is the same or different and is selected from the group consisting of hydrogen, deuterium, —C₁-C₁₀ alkyl, —C₂-C₁₀ alkenyl, —C₃-C₁₀ alkynyl, and —C₃-C₁₀ cycloalkyl.

17. The electrochemical cell of claim 16, wherein the second Lewis acid cation is configured to interact with the carbamic acid compound to release CO₂ from the carbamic acid compound by destabilizing an interaction between an oxygen and a proton of the (R¹)₂NCOOH compound, thereby generating CO₂, a compound of the formula (R¹)₂NH₂⁺, and a compound of the formula (R¹)₂NCOO⁻,
wherein:
each R¹ is the same or different and is selected from the group consisting of hydrogen, deuterium, —C₁-C₁₀ alkyl, —C₂-C₁₀ alkenyl, —C₃-C₁₀ alkynyl, —C₃-C₁₀ cycloalkyl, and —R²—O—R², and
each R² is the same or different and is selected from the group consisting of hydrogen, deuterium, —C₁-C₁₀ alkyl, —C₂-C₁₀ alkenyl, —C₃-C₁₀ alkynyl, and —C₃-C₁₀ cycloalkyl.

18. The electrochemical system of claim 1, wherein the carbamic acid compound comprises carbamic acid, (2-methoxyethyl)carbamic acid, (2-ethoxyethyl)carbamic acid, and/or combinations thereof.

19. The electrochemical system of claim 4, wherein the fluid source is a liquid electrolyte.

20. An electrochemical system, comprising:
a fluid source comprising:
an electrolyte salt comprising a first Lewis acid cation; and
a carbamic acid compound; and
an electrochemical cell comprising a positive electrode and a negative electrode, wherein, upon charge of the electrochemical cell, the positive electrode is configured to produce a second Lewis acid cation that interacts with the carbamic acid compound to release CO₂ from the carbamic acid compound, thereby separating CO₂ from the fluid source, and wherein the second Lewis acid cation is a stronger Lewis acid than the first Lewis acid cation.

21. The electrochemical cell of claim 20, wherein, upon charge of the electrochemical cell, the negative electrode is configured to plate or intercalate the first Lewis acid cation.

22. The electrochemical cell of claim 20, wherein the positive electrode comprises ZnLiV₃O₈, ZnNiₓMnₓCo₂₋₂ₓO₄, ZnAlₓMnₓCo₂₋₂ₓO₄, V₂O₅, Ca_{0.28}V₂O₅·H₂O, FeV₃O₉·1.2H₂O, Ag_{0.33}V₂O₅, NaV₃O₈, Mg_{0.3}V₂O₅·1.1H₂O, and/or α-MoO₃.

23. The electrochemical system of claim 20, wherein the negative electrode comprises Li₄Ti₅O₁₂ or TiO₂.

24-54. (canceled)
